(19) United States
(12) Patent Application Publication
(10) Pub. No.: US 2012/0034583 A1
(43) Pub. Date: Feb. 9, 2012

(54) VETERINARY EXAM PREPARATION ON MOBILE DEVICES

(75) Inventors: Mauricio Dujowich, San Deigo, CA (US); Eric Chan, Hayward, CA (US); Ira K. Gordon, Bethesda, MD (US); Stephen C. Shaw, San Jose, CA (US)

(73) Assignee: VETPREP.COM, INC., Solana Beach, CA (US)

(21) Appl. No.: 12/850,405

(22) Filed: Aug. 4, 2010

(51) Int. Cl. G09B 19/00

(52) U.S. Cl. 434/219

(57) ABSTRACT

An apparatus for use in a process to assist a user to prepare for a veterinary examination includes a computer-readable non-transitory medium storing a veterinary exam practice question, and a plurality of answers that correspond to the veterinary exam practice question, and a processor configured to receive a request from a mobile device, access the medium to retrieve the veterinary exam practice question and the plurality of answers in response to the received request, and provide the retrieved veterinary exam practice question and the plurality of answers for display on the mobile device.

### FIELD

This invention relates to systems and methods for exam preparation, and more specifically, to systems and methods for veterinary exam preparation.

### BACKGROUND

Veterinary medicine is the branch of science that deals with the application of medical, surgical, dental, diagnostic and therapeutic principles to pet, domestic, wildlife and livestock animals. To be a veterinarian, the person needs to graduate with a Doctor of Veterinary Medicine (DVM), and receive his/her license.

In order for a person to obtain the veterinary license, the person needs to receive a passing grade on a national board examination, such as the North America Veterinary Licensing Exam (NAVLE). This exam is eight hours long, and consists of 360 multiple-choice questions. This exam covers all aspects of veterinary medicine, as well as visual material designed to test diagnostic skills.

Currently, there are study programs that assist veterinary students in preparing for veterinary exams, such as the NAVLE. Some of these programs provide text books for students, wherein the books may include practice questions. Other of these programs involves providing practice questions on a computer, which allows the student to take practice questions on the computer.

Applicants of the subject application determine that it would be desirable to have a new device and method for preparing for veterinary exams.

### SUMMARY

In accordance with some embodiments, an apparatus for use in a process to assist a user to prepare for a veterinary examination includes a computer-readable non-transitory medium storing a veterinary exam practice question, and a plurality of answers that correspond to the veterinary exam practice question, and a processor configured to receive a request from a mobile device, access the medium to retrieve the veterinary exam practice question and the plurality of answers in response to the received request, and provide the retrieved veterinary exam practice question and the plurality of answers for display on the mobile device.

In accordance with other embodiments, a method for use in a process to assist a user to prepare for a veterinary examination includes receiving a request from a mobile device, accessing a computer-readable non-transitory medium to retrieve a veterinary exam practice question and a plurality of answers in response to the received request, and providing the retrieved veterinary exam practice question and the plurality of answers for display on the mobile device.

In accordance with other embodiments, a computer-readable non-transitory medium includes a set of stored instructions, an execution of which causes a method to be performed, the method comprising receiving a request from a mobile device, accessing a computer-readable non-transitory medium to retrieve a veterinary exam practice question and a plurality of answers in response to the received request, and providing the retrieved veterinary exam practice question and the plurality of answers for display on the mobile device.

In accordance with other embodiments, an apparatus for assisting a user to prepare for a veterinary examination includes a mobile device having a screen for displaying information, and a user interface for receiving an input from the user, wherein the portable device is configured to display a veterinary exam practice question and a plurality of answers on the screen, and wherein the mobile device is further configured to allow the user to enter the input in response to the displayed veterinary exam practice question using the user interface.

In accordance with other embodiments, a method for assisting a user to prepare for a veterinary examination includes receiving a veterinary exam practice question from a database, receiving a plurality of answers that correspond with the veterinary exam practice question from the database, displaying the veterinary exam practice question and the plurality of answers on a screen of a mobile device, and receiving an input from a user at the mobile device.

In accordance with other embodiments, a computer-readable non-transitory medium includes a set of stored instructions, an execution of which causes a method to be performed, the method comprising receiving a veterinary exam practice question from a database, receiving a plurality of answers that correspond with the veterinary exam practice question from the database, displaying the veterinary exam practice question and the plurality of answers on a screen of a mobile device, and receiving an input from a user at the mobile device.

Other and further aspects and features will be evident from reading the following detailed description of the embodiments, which are intended to illustrate, not limit, the invention.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

FIG. 1 illustrates a database configured to provide veterinary exam practice questions for a mobile device in accordance with some embodiments;

FIG. 2 illustrates a mobile device displaying login information in accordance with some embodiments

FIG. 3 illustrates a main page provided by the database of FIG. 1 for display on a mobile device in accordance with some embodiments;

FIG. 4 illustrates a configuration page for allowing a user of a mobile device to select a practice mode in accordance with some embodiments;

FIG. 5A illustrates an example of sub-categories of veterinary exam practice questions under the Equine category provided by the database of FIG. 1 in accordance with some embodiments;

FIG. 5B illustrates an example of sub-categories of veterinary exam practice questions under the Bovine category provided by the database of FIG. 1 in accordance with some embodiments;

FIG. 5C illustrates an example of sub-categories of veterinary exam practice questions under the Canine category provided by the database of FIG. 1 in accordance with some embodiments;

FIG. 5D illustrates an example of sub-categories of veterinary exam practice questions under the Exotic/pocket pet/fish category provided by the database of FIG. 1 in accordance with some embodiments;

FIG. 5E illustrates an example of sub-categories of veterinary exam practice questions under the Feline category provided by the database of FIG. 1 in accordance with some embodiments;

FIG. 5F illustrates an example of sub-categories of veterinary exam practice questions under the Other food animal category provided by the database of FIG. 1 in accordance with some embodiments;

FIG. 6A illustrates an example of a veterinary exam practice question provided by the database of FIG. 1 in accordance with some embodiments;

FIG. 6B illustrates an example of a selection of a multiple choice answer by the user of a mobile device in accordance with some embodiments;

FIG. 6C illustrates an example of a feedback to a user's answer for a veterinary exam practice question;

FIG. 7 illustrates another example of a feedback to a user's answer for a veterinary exam practice question;

FIG. 8 illustrates another example of a veterinary exam practice question provided by the database of FIG. 1 in accordance with some embodiments;

FIG. 9 illustrates an example of veterinary exam practice question statistics provided by the database of FIG. 1 in accordance with some embodiments;

FIG. 10A illustrates an example of veterinary exam practice question statistics provided by the database of FIG. 1, particularly showing statistics being provided for sub-categories under the Equine category;

FIG. 10B illustrates an example of veterinary exam practice question statistics provided by the database of FIG. 1, particularly showing statistics being provided for sub-categories under the Bovine category;

FIG. 10C illustrates an example of veterinary exam practice question statistics provided by the database of FIG. 1, particularly showing statistics being provided for sub-categories under the Canine category;

FIG. 10D illustrates an example of veterinary exam practice question statistics provided by the database of FIG. 1, particularly showing statistics being provided for sub-categories under the Caprine category;

FIG. 10E illustrates an example of veterinary exam practice question statistics provided by the database of FIG. 1, particularly showing statistics being provided for sub-categories under the Exotic/pocket pet/fish category;

FIG. 10F illustrates an example of veterinary exam practice question statistics provided by the database of FIG. 1, particularly showing statistics being provided for sub-categories under the Feline category;

FIG. 10G illustrates an example of veterinary exam practice question statistics provided by the database of FIG. 1, particularly showing statistics being provided for sub-categories under the Ovine category;

FIG. 10H illustrates an example of veterinary exam practice question statistics provided by the database of FIG. 1, particularly showing statistics being provided for sub-categories under the Porcine category;

FIG. 10I illustrates an example of veterinary exam practice question statistics provided by the database of FIG. 1, particularly showing statistics being provided for sub-categories under the Non-species specific category;

FIG. 11 illustrates example of study categories provided by the database of FIG. 1 in accordance with some embodiments;

FIG. 12 illustrates an example of a list of live lectures provided by the database of FIG. 1 for veterinary exam preparation in accordance with some embodiments;

FIG. 13 illustrates a database configured to provide veterinary exam practice questions for a computer in accordance with some embodiments; and

FIG. 14 is a block diagram of a computer system architecture, with which embodiments described herein may be implemented.

### DESCRIPTION OF THE EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated.

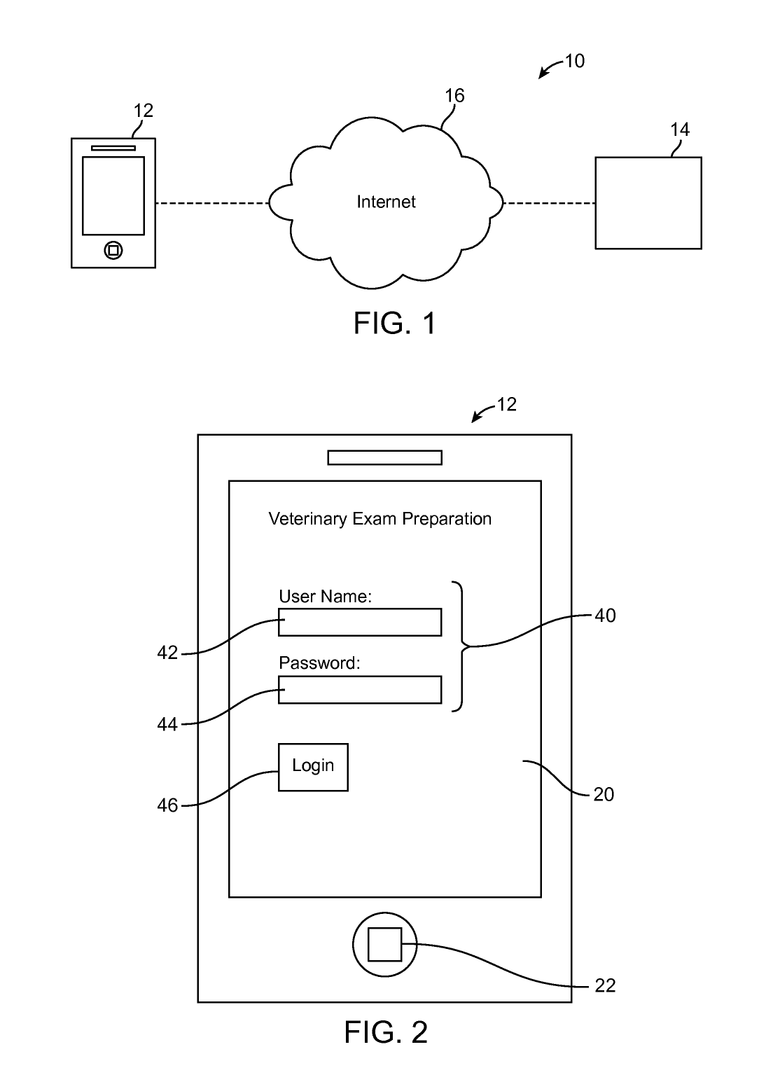

FIG. 1 illustrates a system 10 for preparing a user for a veterinary examination in accordance with some embodiments. As used in this specification, the term “veterinary examination” or similar term refers to any examination in the field of veterinary medicine, included but not limited to North American Veterinary Licensing Examination (NAVLE), Basic Clinical Science Exam (BCSE), Program for the Assessment of Veterinary Education (PAVE), Veterinary Licensing Exam (VLE), Clinical Proficiency Exam (CPE), State Board examination, veterinary school class examination, specialty board exam, continuing education exam, a board examination that is mandatory for veterinary students (e.g., after completing the second year of veterinary school), or any examination related to veterinary subject. The system 10 includes a mobile device 12 that is configured to communicate with a database 14 via the internet 16. In the illustrated embodiments, the mobile device 12 is an iPhone. In other embodiments, the mobile device 12 may be a Blackberry, an iPad, an ipod (Touch), a Palm, a PDA, or an Android. Also, as used in this specification, the term “database” may refer to any device or software that is configured (e.g., built, programmed, or both) to provide data or cause data to be provided. For examples, in some embodiments, the database 14 may be implemented using one or more computers, one or more processors, software, or combination of any of the foregoing.

As shown in FIG. 2, the mobile device 12 includes a screen 20 for displaying information, such as any of the information described herein, and a button 22 for allowing the user of the mobile device 12 to control one or more functionalities of the device 12. In the illustrated embodiments, because the mobile device 12 is an iPhone, the screen 20 is a touch-screen, which allows the user to enter user input by touching the screen 20. In other embodiments, the mobile device 12 may include a keyboard and/or numeric keys for allowing the user to enter input. In addition, or alternatively, the mobile device 12 may further include a joystick, a touch pad, a rolling ball, etc., for allowing the user to control a cursor or pointer displayed in the screen 20.

In accordance with some embodiments, in response to a request to access the database 14 received from the mobile device 12, the database 14 is configured to provide information for display on the mobile device 12 for assisting a user of the mobile device 12 to prepare for a veterinary examination. In the illustrated embodiments, the mobile device 12 may be used to launch a program, such as an internet application, for allowing the user of the mobile device 12 to access the database 14 using the internet application, e.g., by typing in an address that is associated with the database 14. The database 14 is configured to receive the request from the mobile device 12, and in response to the request, provide login information 40 for display on the screen 20 of the mobile device 12.

In some embodiments, the mobile device 12 is configured (e.g., programmed) to display content from the database 14 for smaller screen resolution. Also, in some embodiments, the mobile device 12 is configured to automatically adjust the screen resolution based on the content provided by the database 14. For example, if the content from the database 14 involves a picture, then the screen resolution may be enhanced. In further embodiments, the mobile device 12 may be configured to automatically adjust the size of objects (e.g., text, picture, etc.) provided by the database 14 for display on the screen 20 of the mobile device 12, and/or screen resolution, based on an orientation of the mobile device 12. For example, for the case in which the mobile device 12 is an iPhone, and the mobile device 12 is viewed horizontally (i.e., in landscape view), then the mobile phone 12 may be configured to scale the objects to be larger, and/or to reduce the resolution. On the other hand, when the mobile device 12 is viewed vertically (i.e., in portrait view), then the mobile phone 12 may be configured to scale the objects to be smaller, and/or to enhance the resolution.

In the illustrated embodiments, the login information 40 includes a name field 42 for allowing the user of the mobile device 12 to type in a login name of the user, and a password field 44 for allowing the user to type in a password. In some embodiments, the login name may be any information associated with the user, including but not limited to an email, an alias name, a phone number, etc. After the user has input the user name and the password, the user may select “Login” 46 to send the user name and the password to the database 14 for evaluation.

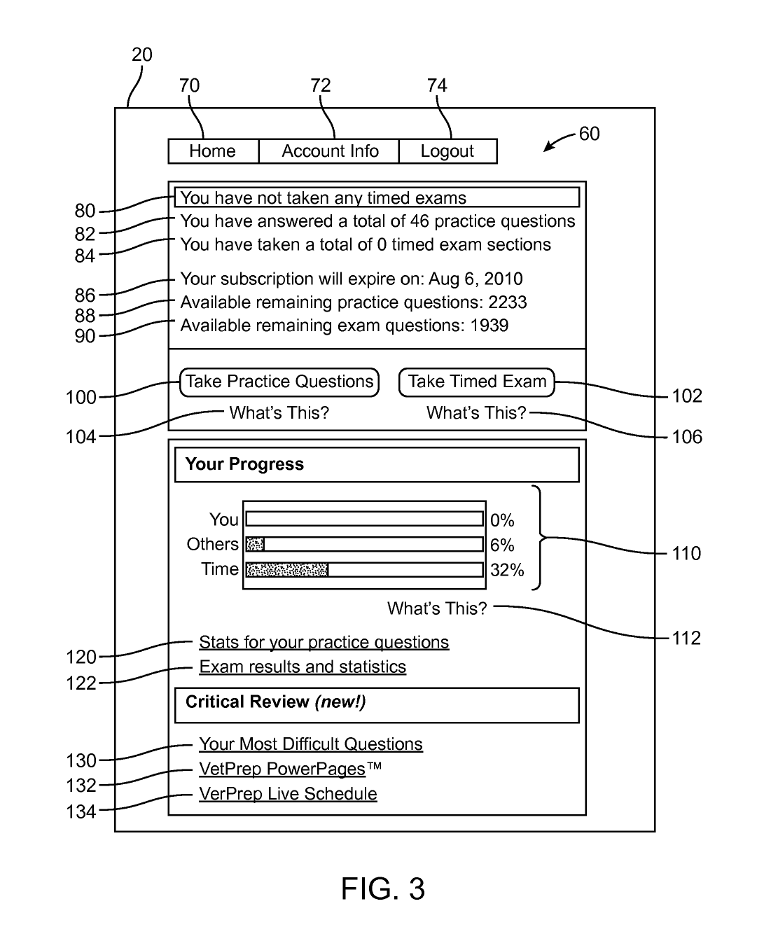

When the database 14 received the user name and the password, the database 14 looks up a table that stores authorized user names and their corresponding passwords to determine whether the user is an authorized user. When the database 14 determines that the user is an authorized user, the database 14 then allows the user to access additional information from the database 14. As shown in FIG. 3, in some embodiments, after determining that the user is an authorized user, the database 14 may provide a page 60 for display on the mobile device 12. The page 60 includes a “Home” button 70, an “Account info” button 72, and a “Logout” button 74. In the illustrated embodiments, the buttons 70, 72, 74 stay displayed on the screen 20 of the mobile 12 as the user navigates to different pages provided by the database 14.

The “Home” button 70 may be selected by the user (e.g., by touching the portion of the screen 20 where the “Home” button 70 is located), which allows the user to navigate from the current page back to the main page 60.

The “Account info” button 72 may be selected by the user (e.g., by touching the portion of the screen 20 where the “Account info” button 72 is located). In response, the database 14 is configured to provide information regarding the account info for the user for display on the screen 20 of the mobile device 12. By means of non-limiting examples, the account info may include user name, login name, password, account activation date, account expiration date, veterinary school in which the user is enrolled, etc.

The “Logout” button 74 may be selected by the user (e.g., by touching the portion of the screen 20 wherein the “Logout” button 74 is located) to logout from a session for accessing the database 14.

As shown in FIG. 3, the page 60 also includes an indicator 80 for informing the user of the mobile device 12 whether the user has taken any timed exam. If the user has taken timed exam(s), the page 60 also provides another indicator 84 for informing the user of the mobile device 12 a number of timed exam(s) taken. In the illustrated example, the indicator 80 indicates that the user of the mobile device 12 has not taken any timed exam. The page 60 also includes an indicator 82 for informing the user of the mobile device 12 a total number of veterinary exam practice questions taken by the user.

As shown in FIG. 3, the page 60 also includes an indicator 86 for informing the user of the mobile device 12 the date that the user's subscription to the database 14 will expire, an indicator 88 for informing the user of the mobile device 12 the number of available remaining veterinary exam practice questions that have not been taken by the user, and an indicator 90 for informing the user of the mobile device 12 the number of available remaining veterinary exam questions that have not been taken by the user

Returning to FIG. 3, the page 60 also includes a “Take practice questions” button 100, and a “Take timed exam” button 102. In the illustrated embodiments, each of the buttons 100, 102 may be selected by touching the portion of the screen 20 where the button is displayed. In other embodiments, each of the buttons 100, 102 may be selected by positioning (e.g., using a joystick, a touchpad, rolling ball, etc.) a cursor or a highlighting over the button, and then pressing an input button on the mobile device 12. When the button 100 is selected, the database 14 will provide a series of veterinary exam practice questions in a practice format in which the database 14 provides feedback (e.g., correct answer and/or explanation of the correct answer) to the user after each question is answered by the user, so that the user can know right away whether he/she misses the question and learn about the correct answer. On the other hand, when the button 102 is selected, the database 14 will provide a series of veterinary exam practice questions in an exam format (e.g., a timed simulated exam session), in which the database 14 does not provide feedback to the user after each question is answered by the user. As shown in the figure, the page 60 also includes a link/button 104, which when selected by the user, will cause an explanation of the “Take practice questions” mode associated with the button 100 to be displayed on the screen 20 of the mobile device 12, thereby allowing the user to learn more about the “Take practice questions” mode before selecting its associated button 100. The page 60 also includes a link/button 106, which when selected by the user, will cause an explanation of the “Take timed exam” mode associated with the button 102 to be displayed on the screen 20 of the mobile device 12, thereby allowing the user to learn more about the “Take timed exam” mode before selecting its associated button 102.

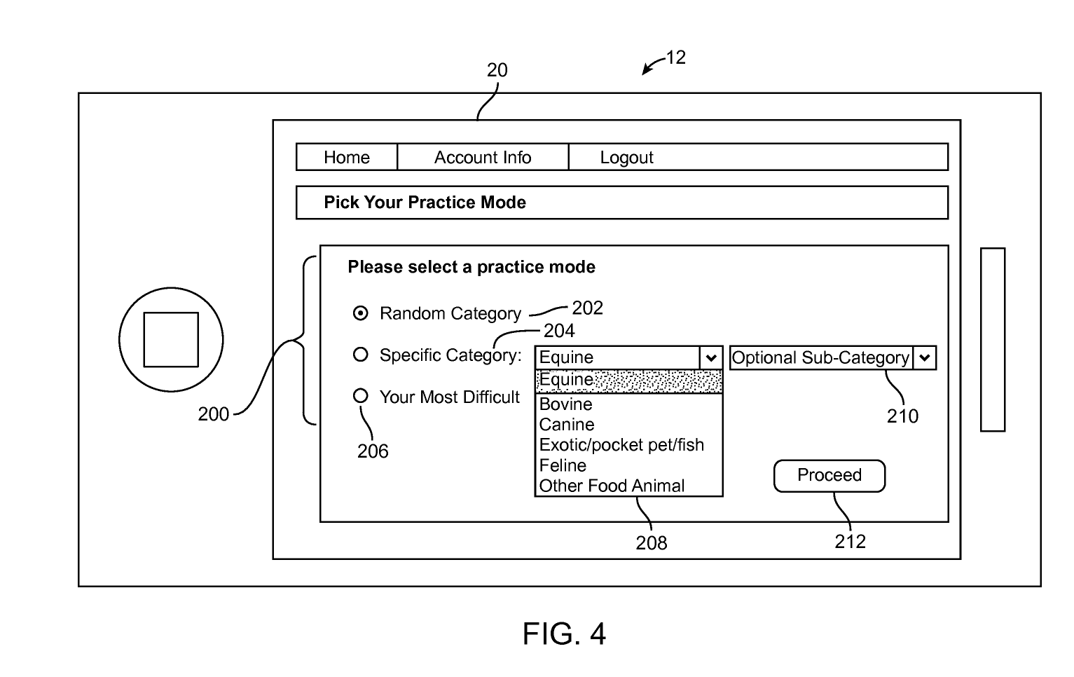

When the user of the mobile device 12 selects the “Take practice questions” button 100, the database 14 provides a practice mode menu 200 for display on the screen 20 of the mobile device 12, which allows the user to select different practice modes (FIG. 4). The practice mode menu 200 includes “Random category” 202, “Specific category” 204, and “Your most difficult questions” 206. If the user of the mobile device 12 selects “Random category” 202, the database 14 then randomly selects veterinary exam practice questions from a pool of available practice questions for display on the screen 20 of the mobile device 12. If the user of the mobile device 12 selects “Specific category” 204, the database 14 then provides veterinary exam practice questions only from the selected category by the user. If the user of the mobile device 12 selects “Your most difficult questions” 206, the database 14 then provides veterinary exam practice questions that the user has failed previously, or that the user has failed more than a prescribed number (e.g., two or more) of times. The prescribed number of times may be determined by an administrator of the database 14, or alternatively, be determined by the user of the mobile device 12 through a user interface provided by the database 14.

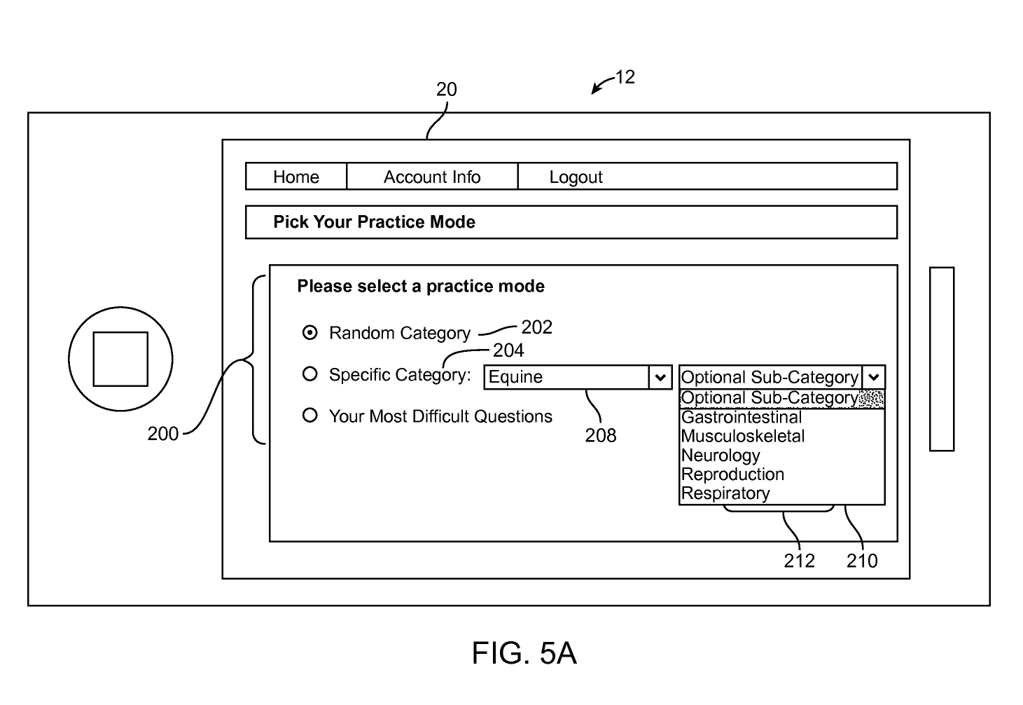

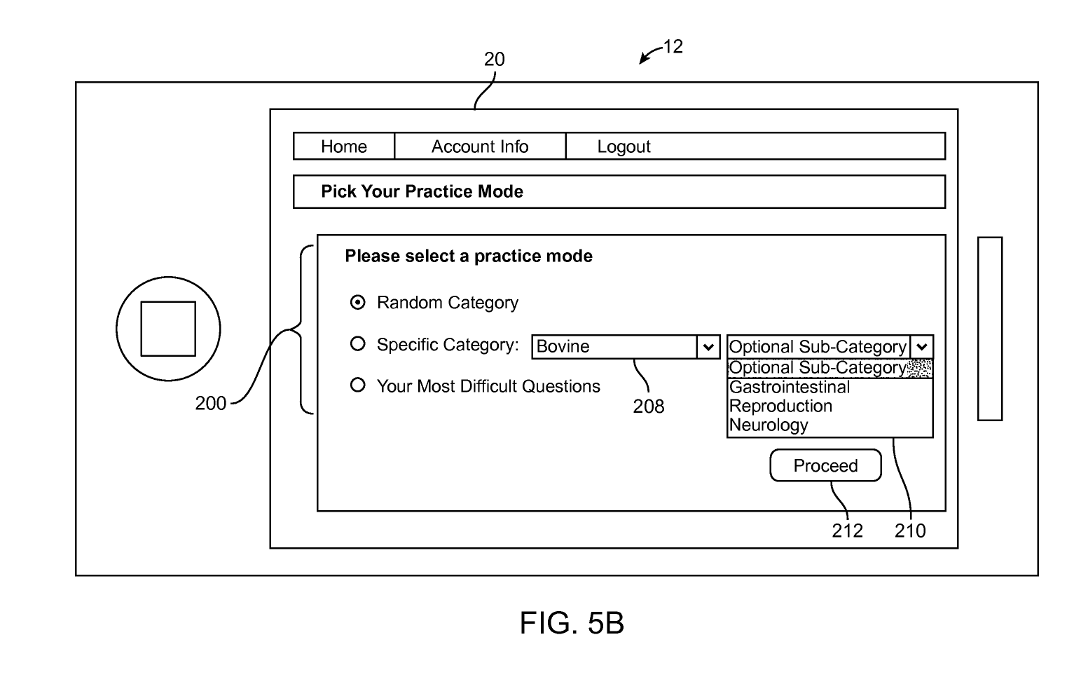

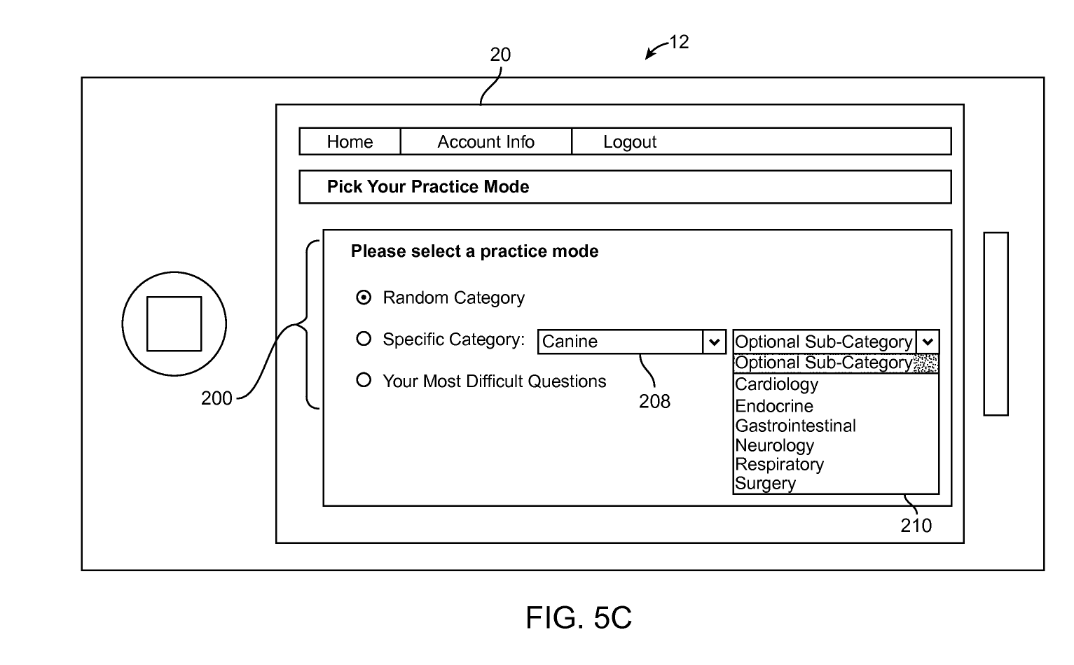

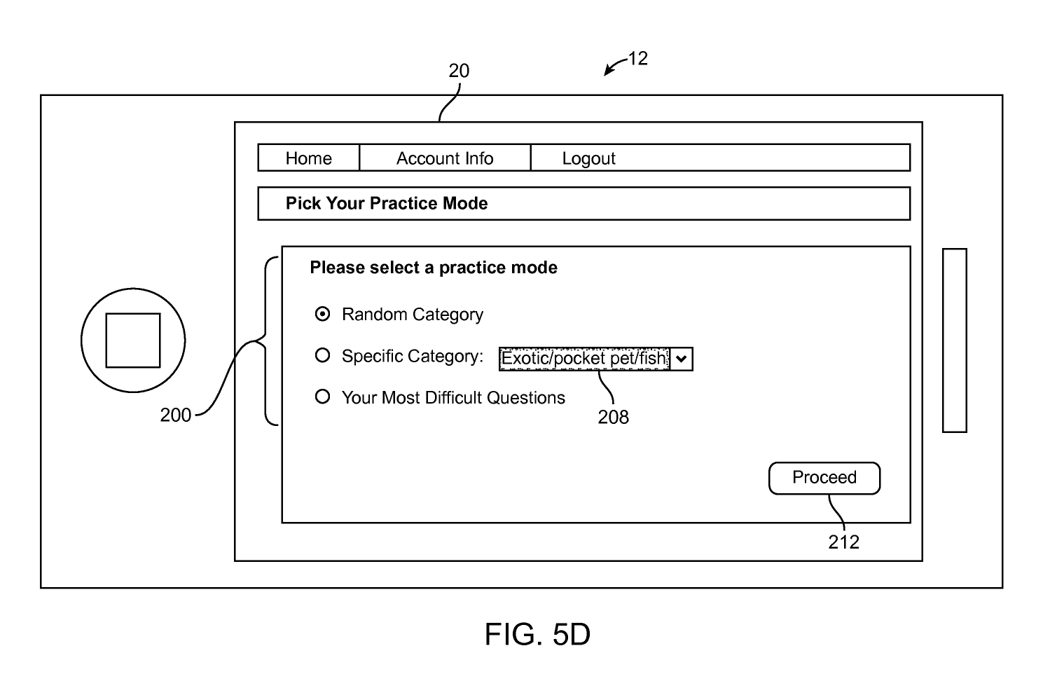

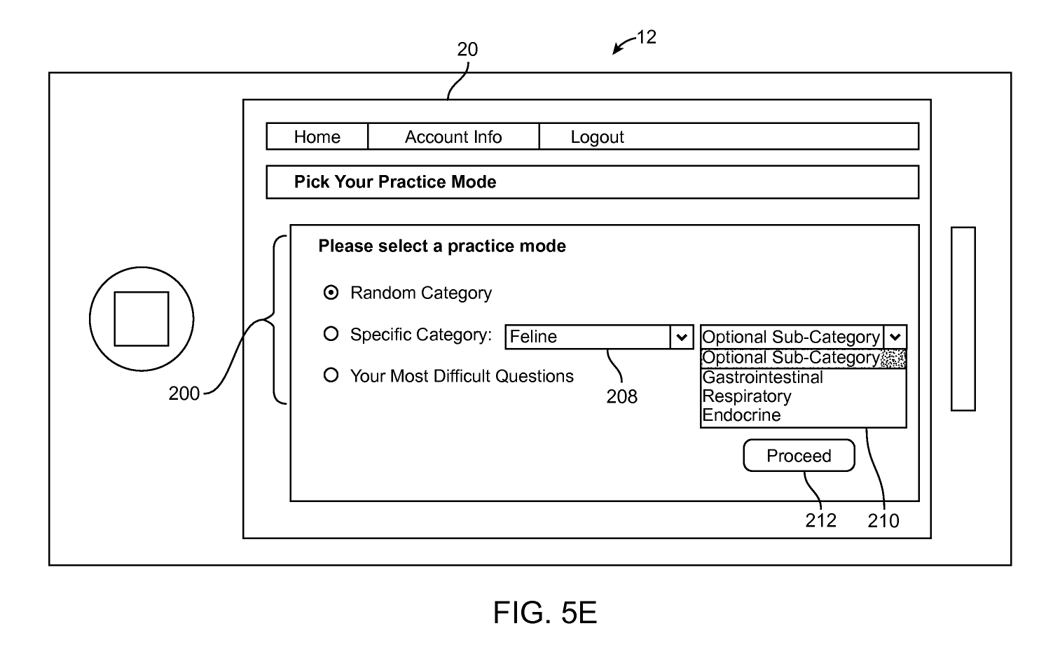

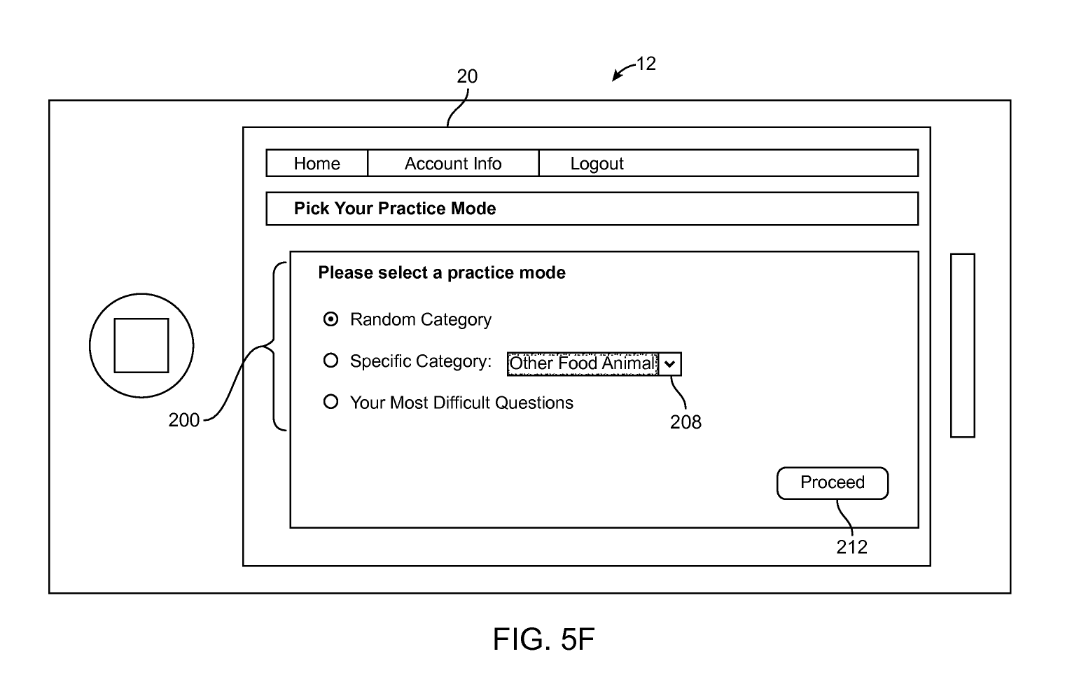

As shown in FIGS. 5A-5F, the database 14 also provides a pull-down menu 208 for display on the mobile device 12, wherein the pull-down menu 208 includes different subject categories for allowing the user of the mobile device 12 to choose from. In the illustrated embodiments, the pull-down menu 208 includes the subject categories: Equine, Bovine, Canine, Exotic/pocket pet/fish, Feline, and Other food animal. In other embodiments, the pull-down menu 208 may include one or more additional categories. Also, in further embodiments, any of the categories under the pull-down menu 208 described above may not be included.

If the user selects “Equine” in the pull-down menu 208, then the database 14 provides a second pull-down menu 210 that provides sub-categories under the subject category of “Equine” for display on the mobile device 12 (FIG. 5A). The sub-categories under “Equine” include Gastrointestinal, Musculoskeletal, Neurology, Reproduction, and Respiratory. The user of the mobile device 12 may select one of these sub-categories under the pull-down menu 210, and in response, the database 14 will provide only those veterinary exam practice questions that fall under the selected sub-category of “Equine.” In other embodiments, the menu 210 may further include an “All” selection which when selected by the user, will cause the database 14 to provide questions from all sub-categories under the “Equine” category. In further embodiments, the database 14 may not provide the second pull-down menu 210. In such cases, questions from all sub-categories under “Equine” will be provided by the database 14 for display on the screen 20 of the mobile device 12.

If the user selects “Bovine” in the pull-down menu 208, then the database 14 provides a second pull-down menu 210 that provides sub-categories under the subject category of “Bovine” for display on the mobile device 12 (FIG. 5B). The sub-categories under “Bovine” include but are not limited to Gastrointestinal, Reproduction, and Respiratory. The user of the mobile device 12 may select one of these sub-categories under the pull-down menu 210 (e.g., by choosing the sub-category, and pressing/selecting the “proceed” button 212, or alternatively, by just choosing the sub-category), and the database 14 will provide only those veterinary exam practice questions that fall under the selected sub-category of “Bovine.” In other embodiments, the menu 210 may further include an “All” selection which when selected by the user, will cause the database 14 to provide questions from all sub-categories under the “Bovine” category. In other embodiments, the database 14 may not provide the second pull-down menu 210. In such cases, questions from all sub-categories under “Bovine” will be provided by the database 14 for display on the screen 20 of the mobile device 12.

If the user selects “Canine” in the pull-down menu 208, then the database 14 provides a second pull-down menu 210 that provides sub-categories under the subject category of “Canine” for display on the mobile device 12 (FIG. 5C). The sub-categories under “Canine” include but are not limited to Cardiology, Endocrine, Gastrointestinal, Neurology, Respiratory, and Surgery. The user of the mobile device 12 may select one of these sub-categories under the pull-down menu 210 (e.g., by choosing the sub-category, and pressing/selecting the “proceed” button 212, or alternatively, by just choosing the sub-category), and the database 14 will provide only those veterinary exam practice questions that fall under the selected sub-category of “Canine.” In other embodiments, the menu 210 may further include an “All” selection which when selected by the user, will cause the database 14 to provide questions from all sub-categories under the “Canine” category. In further embodiments, the database 14 may not provide the second pull-down menu 210. In such cases, questions from all sub-categories under “Canine” will be provided by the database 14 for display on the screen 20 of the mobile device 12.

If the user selects “Exotic/pocket pet/fish” in the pull-down menu 208 (e.g., by choosing the category, and pressing/selecting the “proceed” button 212, or alternatively, by just choosing the category), then the database 14 provides veterinary exam practice questions under such selected category (FIG. 5D). In the illustrated embodiments, the subject category “Exotic/pocket pet/fish” does not have any sub-categories. In other embodiments, when the subject category “Exotic/pocket pet/fish” is selected, the database 14 may provide a second pull-down menu that provides sub-categories under the subject category of “Exotic/pocket pet/fish” for display on the mobile device 12. In such cases, the user of the mobile device 12 may select one of these sub-categories under the second pull-down menu (e.g., by choosing the sub-category, and pressing/selecting the “proceed” button 212, or alternatively, by just choosing the sub-category), and the database 14 will provide only those veterinary exam practice questions that fall under the selected sub-category of “Exotic/pocket pet/fish.” In other embodiments, the second menu may further include an “All” selection which when selected by the user, will cause the database 14 to provide questions from all sub-categories under the “Exotic/pocket pet/fish” category.

If the user selects “Feline” in the pull-down menu 208, then the database 14 provides a second pull-down menu 210 that provides sub-categories under the subject category of “Feline” for display on the mobile device 12 (FIG. 5E). The sub-categories under “Feline” include but are not limited to Gastrointestinal, Respiratory, and Endocrine. The user of the mobile device 12 may select one of these sub-categories under the pull-down menu 210 (e.g., by choosing the sub-category, and pressing/selecting the “proceed” button 212, or alternatively, by just choosing the sub-category), and the database 14 will provide only those veterinary exam practice questions that fall under the selected sub-category of “Feline.” In other embodiments, the menu 210 may further include an “All” selection which when selected by the user, will cause the database 14 to provide questions from all sub-categories under the “Feline” category. In other embodiments, the database 14 may not provide the second pull-down menu 210. In such cases, questions from all sub-categories under “Feline” will be provided by the database 14 for display on the screen 20 of the mobile device 12.

If the user selects “Other food animal” in the pull-down menu 208 (e.g., by choosing the category, and pressing/selecting the “proceed” button 212, or alternatively, by just choosing the category), then the database 14 provides veterinary exam practice questions under such selected category (FIG. 5F). In the illustrated embodiments, the subject category “Other food animal” does not have any sub-categories. In other embodiments, when the subject category “Other food animal” is selected, the database 14 may provide a second pull-down menu that provides sub-categories under the subject category of “Other food animal” for display on the mobile device 12. In such cases, the user of the mobile device 12 may select one of these sub-categories under the pull-down menu (e.g., by choosing the sub-category, and pressing/selecting the “proceed” button 212, or alternatively, by just choosing the sub-category), and the database 14 will provide only those veterinary exam practice questions that fall under the selected sub-category of “Other food animal.” In other embodiments, the second menu may further include an “All” selection which when selected by the user, will cause the database 14 to provide questions from all sub-categories under the “Other food animal” category.

It should be noted that the subject categories and sub-categories provided by the database 14 should not be limited to the examples described previously, and that in other embodiments, the database 14 may provide one or more additional subject categories, and/or one or more additional sub-categories, for display on the screen 20 of the mobile device 12. For example, in other embodiments, the database 14 may provide Caprine, Ovine, and/or Porcine as additional subject category in the menu 208 for allowing the user of the mobile device 12 to select. In further embodiments, the database 14 may not provide all of the subject categories or all of the sub-categories described previously. Therefore, in other embodiments, one or more of the previously described subject categories, and/or one or more of the previously described sub-categories may be omitted. In still further embodiments, the database 14 may provide a third pull-down menu that includes further sub-categories under a selected one of the sub-categories in the second pull-down menu 210.

In the illustrated embodiments, the database 14 is configured to use an algorithm to randomize the order of veterinary exam practice questions that are presented to the user. In particular, the database 14 is configured to determine a pool of available practice questions, and use the random algorithm to randomly select practice questions from the pool for presentation to the user. In some embodiments, the pool of available practice questions may be all questions that are stored at the database 14. In other embodiments, the pool of available practice questions may be a subset of all questions that are stored at the database 14, such as only questions that are within a subject category or sub-category as determined by the user, or only questions that have other attribute(s). In some embodiments, the database 14 is configured to remove correctly answered questions from the pool of available practice questions, so that the correctly answered questions by the user will not be selected by the random algorithm, and will not appear again during a practice session. Also, in some embodiments, the random algorithm may be configured to consider the performance of the user when randomly selects practice questions for presentation to the user. For example, in some embodiments, the database 14 keeps track which questions were previously missed by the user. Such questions are flagged in the database 14, and a higher weight factor may be applied to such questions so that they will have a higher probability (compared with the remaining questions in the pool of available questions) of being selected by the random algorithm.

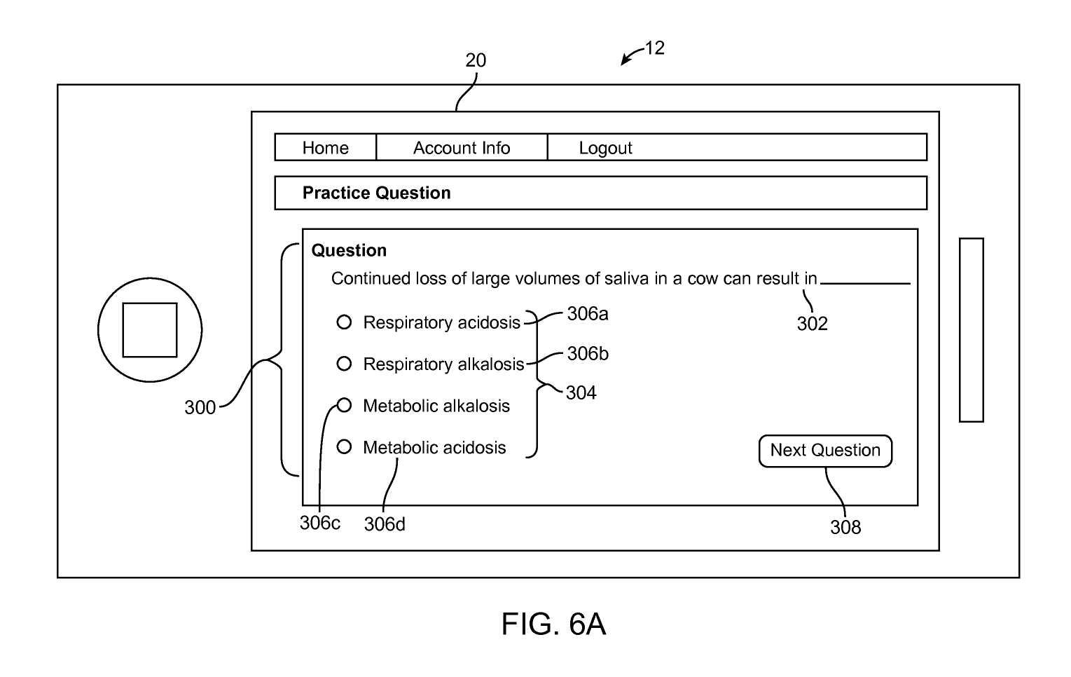

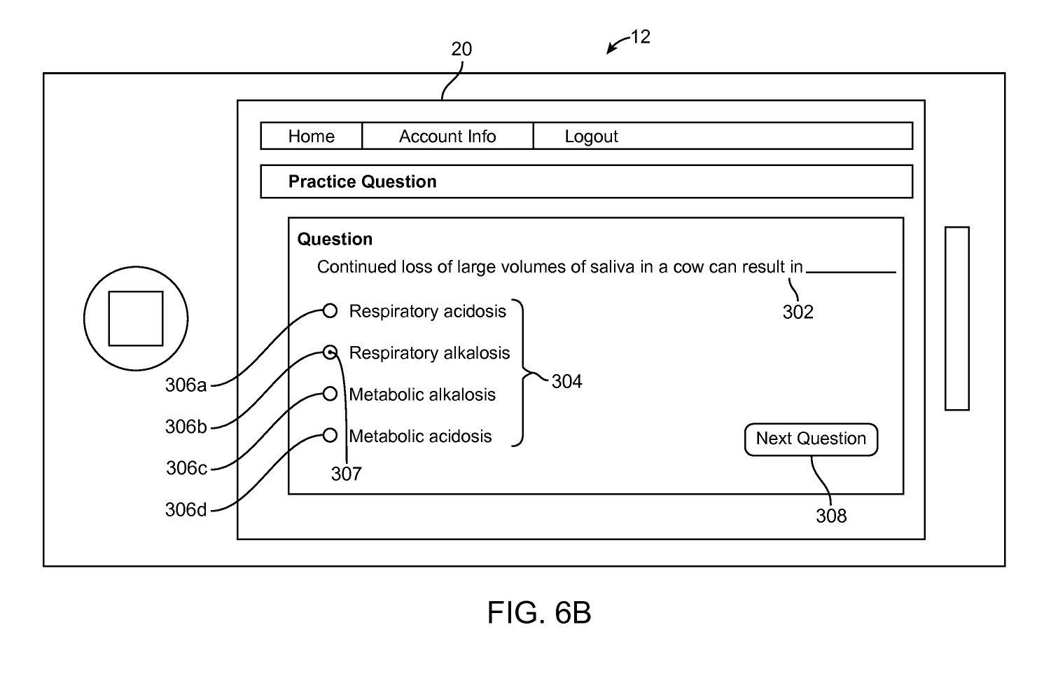

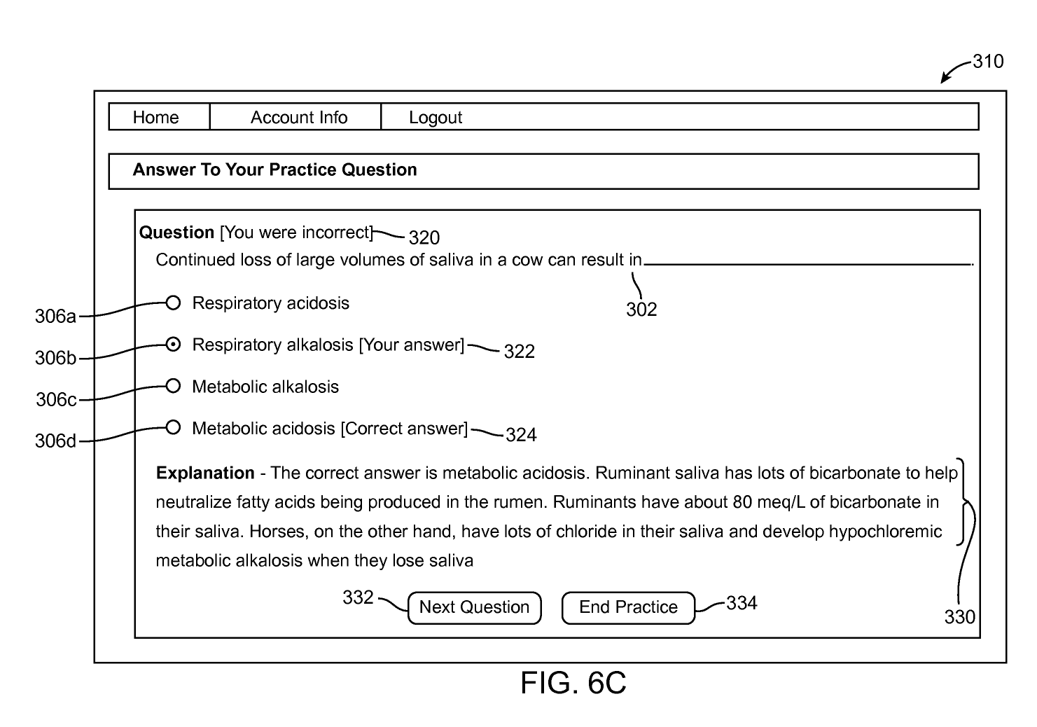

FIG. 6A illustrates an example of a veterinary exam practice question 300 that is provided by the database 14 for display on the screen 20 of the mobile device 12. The practice question 300 includes a question portion 302, and a multiple-choice portion 304. The multiple-choice portion 304 includes multiple-choices 306a-306d. In other examples, the multiple-choice portion 304 may have more than four multiple-choices. In the illustrated embodiments, the user of the mobile device 12 may select any one of the multiple-choices 306a-306d by touching the part of the screen 20 wherein the multiple-choice is displayed. In other embodiments, the screen 20 is not a touch-screen, and the user may then select any one of the multiple-choices 306a-306d using other input mechanism, such as a keyboard, a joystick, a touchpad, a rolling ball, etc.

In the example shown in FIG. 6B, the multiple-choice 306b is selected, and an indicator 307 is displayed on the screen 20 next to the selected multiple-choice 306b for indicating to the user that the multiple-choice 306b has been selected. The user may then select the “Next question” button 308 displayed on the screen 20, thereby indicating that the selected multiple-choice is the user's final decision. In other embodiments, in addition to, or instead of, highlighting the selected multiple choice 82b by displaying a graphic (e.g., a check mark, a filled bubble, etc.) next to the selected multiple-choice 82b, the selected multiple-choice 82b may be highlighted in other way, such as by changing the format (e.g., color, size, style, etc.) of the text of the selected multiple-choice 82b. Also, in further embodiments, instead of requiring a two-step process (in which the user selects a multiple-choice first, and then select “Next question” button 308 to confirm the selection), the mobile device 12 may be configured to provide a one-touch answer, wherein when the user selects one of the multiple-choices (e.g., by touching the portion of the screen 20 where the multiple-choice is displayed), the answer is then selected and submitted for evaluation without requiring any further action by the user.

Upon receiving a signal from the mobile device 12 that the user has selected multiple-choice 306b, the database 14 determines whether the selected multiple-choice 306b is the correct answer. In the illustrated embodiments, the database 14 stores information regarding the correct answer for each veterinary exam practice question. In the illustrated example, based on such stored information, the database 14 determines that the correct answer is “Metabolic acidosis” 306d, and therefore, the selected multiple-choice 306b by the user is incorrect. As shown in FIG. 6C, the database 14 provides an indicator 320 for display on the screen 20 of the mobile device 12 for informing the user that the selected multiple-choice 306b is “incorrect.” The database 14 also provides a selection indicator 322 for informing the user which answer he/she selected, and a correct answer indicator 324 for informing the user which multiple-choice is the correct answer. In other embodiments, color code may be used to identify correct and incorrect answers (e.g., correct answer may be highlighted in green, and incorrect multiple-choices or the incorrect answer may be highlighted in red). The database further provides an explanation 330 for display on the screen 20 of the mobile device 12 for explaining to the user why the multiple-choice 306b in the example is the correct answer. As shown in the figure, if the user is ready for the next question, the user may select the “Next question” button 332. Alternatively, if the user wishes to end the practice session, the user may select the “End practice” button 334.

In some embodiments, as the user goes through the practice questions using the mobile device 12, the database 14 keeps track of the information regarding the user's performance, and builds a statistic profile using such information. By means of non-limiting examples, the information regarding the user's performance may include one or more of a total number of questions answered correctly, total number of questions answered incorrectly, number of questions answered correctly in each subject category, and number of questions answered incorrectly in each subject category. Also, in some embodiments, when providing feedback information, such as those described with reference to FIG. 6C, the database 14 may also provide a user interface (e.g., a check box) for allowing the user to mark a question for review later. In such cases, if the user marks the question (e.g., by touching the portion of the screen 20 where the check box is displayed), the database 14 will flag the question, indicating that the user may wish to retrieve such question for review later. In the illustrated embodiments, the statistics regarding the user's performance in taking the veterinary exam practice questions is stored in a non-transitory medium associated with the database 14, so that the user of the mobile device 12 may retrieve them at a later time.

It should be noted that the manner in which the user is informed of the correct answer is not limited to the visual information described, and that the user may be informed of the correct answer using other techniques. For example, in other embodiments, in addition to, or in the alternative of, providing the visual indicators 320, 322, 324, the database 14 may provide audio data for the mobile device 12. The mobile device 12 processes the audio data, and provides an audio signal (e.g., an audio message) through its speaker for informing the user of the correct answer. The database 14 may also provide other types of audio data, such as audio data for informing user whether his/her answer is correct or not, audio data for explaining the correct answer, etc. In response to receiving such audio data from the database 14, the mobile device 12 provides an audio signal to the user of the mobile device 12 accordingly.

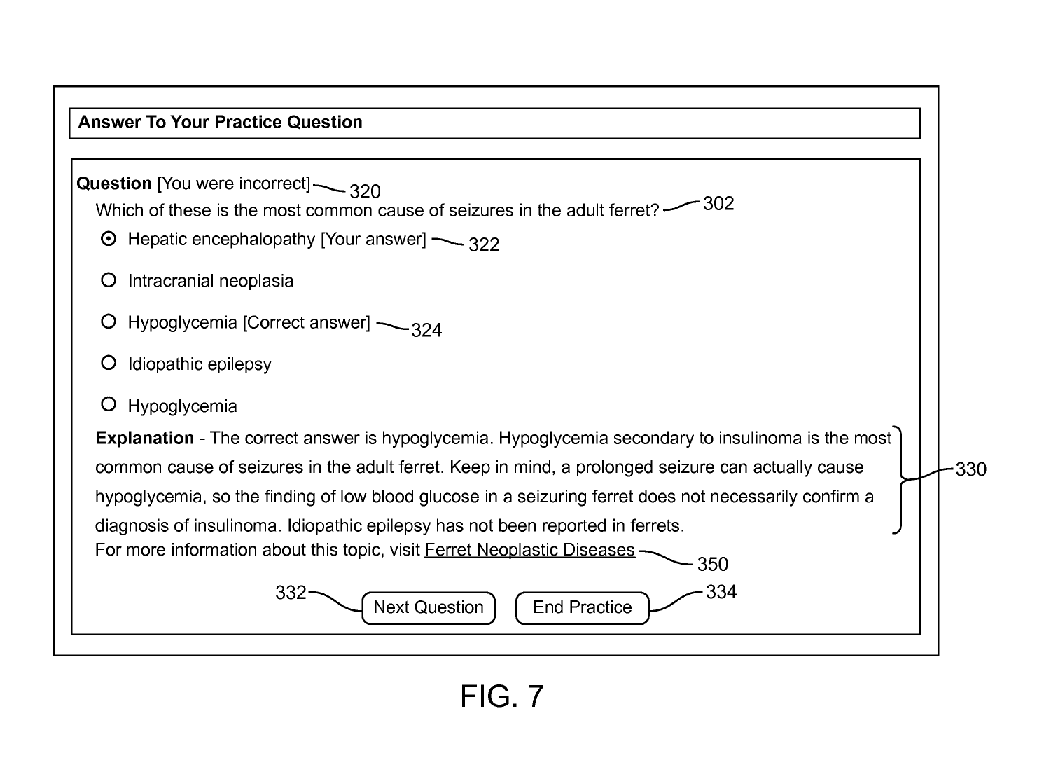

In other embodiments, in addition to providing an explanation for the correct answer to the veterinary exam practice question, the database 14 may also provide additional information for display on the screen 20 of the mobile device 12, which allows the user to learn more about the subject related to the answered veterinary exam practice question. For example, in any of the embodiments described herein, the feedback from the database 14 regarding the user's selection of the multiple choice may also include a link 350 for display on the screen 20 of the mobile device 12 (FIG. 7). When the link 350 is selected by the user (e.g., by touching the portion of the screen 20 where the link 350 is located), the database 14 will cause information associated with the link 350 to be transmitted to the mobile device. By means of non-limiting examples, the information may be an outline, a study note, a lecture note, or any information relating to the subject matter of the practice question that the user just answered. Also, the information may be presented in the form of a webpage, a pdf, a text file, an image file, an animation, an audio file, or a video file. In some embodiments, some or all of the information provided by the database 14 may be sponsored reading materials that are study aids for assisting the user to prepare for the veterinary exam. Also, in any of the embodiments described herein, the study aid information may be provided by the database 14 using push-technology, in which the database 14 is configured to “push” such information to the mobile device 12. For example, in some embodiments, study materials may be provided by the database 14 to the mobile device 12 in the form of text message(s). In other embodiments, the study materials may be provided by the database 14 to the mobile device 12 in the form of email(s) or audio message(s).

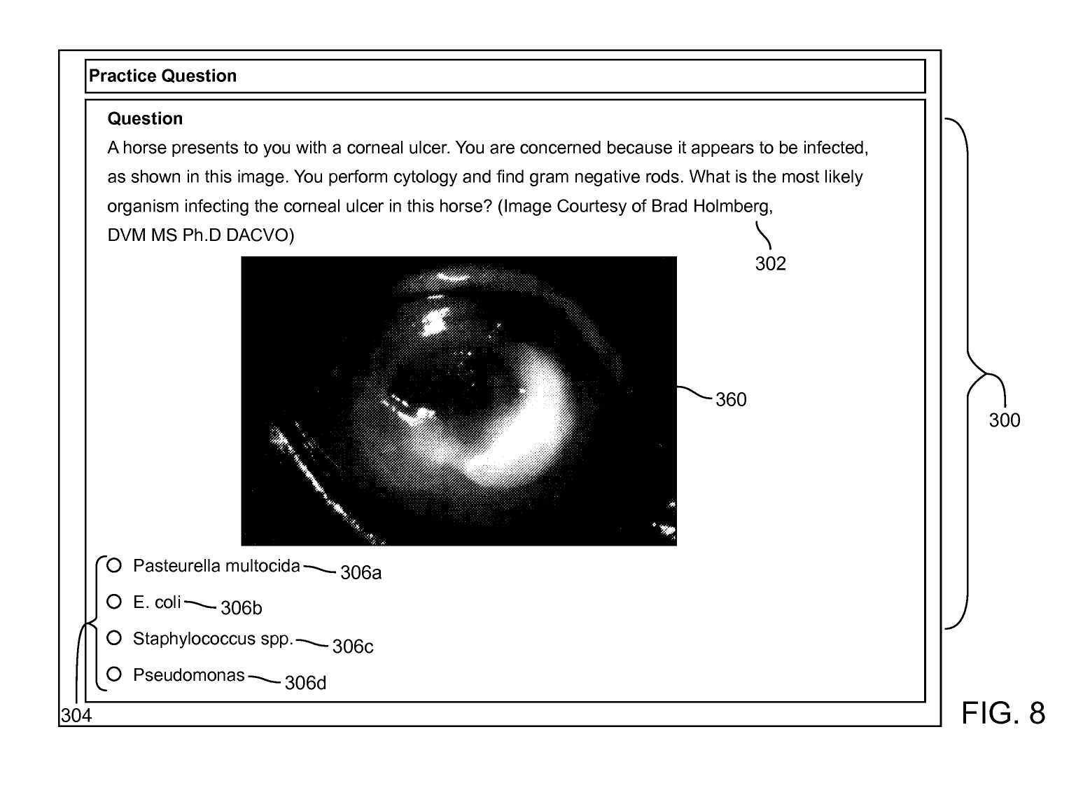

In other embodiments, the veterinary exam practice question provided by the database 14 for display on the screen 20 of the mobile device 12 may also include a FIG. 360 (FIG. 8). In the illustrated embodiments, the FIG. 360 is a photograph. In other embodiments, the FIG. 360 may be a diagram, a graph, a table, etc. The FIG. 360 may be stored in the database 14, and is associated with the practice question 300 in the database 14. When the database 14 selects the veterinary exam practice question 300 for display on the screen 20 of the mobile device 12, the database 14 retrieves the FIG. 360 together with the question portion 302 and the multiple-choice portion 304, and transmits these information over the internet 16 for display on the screen 20 of the mobile device 12. In some embodiments, the FIG. 360 in the screen 20 may be zoomed in (e.g., by touching the screen 20 with two fingers and moving the two fingers apart while touching the screen 20, or by clicking a button for zoomed-in function) or zoomed out (e.g., by touching the screen 20 with two fingers and moving the two fingers together while touching the screen 20, or by clicking a button for zoomed-out function) using the mobile device 12. Providing questions with pictures is advantageous in that it allows the database 14 to test the diagnostic skills of the user in some embodiments.

In some embodiments, when the user selects the “Take practice questions” button 100, the database 14 provides a user interface for display on the screen 20 of the mobile device 12, that allows the user to request whether to receive only practice questions without any images, receive only practice questions with images, or receive both practice questions with images and practice questions without images. In other embodiments, instead of, or in addition to, allowing the user to prescribe whether to receive practice questions based on the image attribute, the database 14 may be configured to allow the user to configure the practice questions mode based on other attributes, such as one or more attributes of questions (e.g., questions that are within a certain subject category or sub-category, as discussed, questions that involves hypothetical, questions that ask about definitions of medical terms, etc.), and/or one or more attributes of answers (e.g., questions for which the answers have video explanation, questions for which the answers have study notes, etc.).

In one implementation, the database 14 may include a medium for storing a set of veterinary exam practice questions. Each practice question may include the text of the question and the text of the multiple choices. Also, each practice question may include an index that identifies the practice question, and a plurality of attributes with corresponding attribute values. In some embodiments, the attributes include a subject category attribute that identifies the subject category to which the question belongs, a sub-category attribute that identifies the sub-category to which the question belongs, a status attribute that identifies whether the question was answered correctly by the user, a question number attribute that identifies the number of times the question was previously presented to the user, a flag attribute for identifying whether the question was flagged by the user for later review, and a picture attribute that identifies whether there is a picture associated with the question (and if so, the storage location for accessing the picture).

In one algorithm for providing a practice question by the database 14, the database 14 is configured to receive configuration commands from the user of the mobile device 12, which prescribes the type of practice questions desired by the user. For example, the configuration command may be one that asks the database 14 to provide practice questions that are under the “Feline” category, and the “Respiratory” sub-category within the “Feline” subject category. When the database 14 receives the configuration command, the database 14 then determines a pool of available questions that satisfy the configuration command. In the illustrated example, the database 14 retrieves all questions with subject category attribute's value of “Feline” and sub-category attribute's value of “Respiratory,” thereby forming a pool of available questions for presentation to the user. Also, if the user sends a configuration command using the mobile device 12 to request only questions that have pictures, then the database 14 will further reduce the pool of available questions by including only questions that have picture attribute's value of “1” (wherein “1” indicates that there is a picture associated with the question, and “0” indicates that there is no picture associated with the question). In addition, the database 14 may further reduce the pool of available questions by excluding questions that have already been answered correctly. In such case, the database 14 may use the status attribute to identify those questions that have already been answered correctly, and exclude them from the pool of available questions. Once the final pool of available questions is determined, the database 14 then uses the random algorithm to randomly select practice questions, one at a time, from the current pool of available questions. As the user goes through the practice questions, the attribute values of the questions that have been presented to the user are updated, and the pool of available questions is updated after each question that has been presented to the user. For example, when a practice question is presented to the user, the question number attribute for that practice question that identifies the number of times the question was previously presented to the user will be updated (e.g., increase the value by 1). Also, if a question is answered correctly, the status attribute for that question is updated, and the database 14 will exclude such question (e.g., using the status attribute) from the pool of available questions for providing the next practice question.

The feature of allowing the user to take practice questions using the mobile device 12 is advantageous. Such a feature allows the user to take practice questions anywhere. For example, the user may be commuting in a bus or train, may be waiting in line, or may be at a location where there is no power and/or wi-fi for a computer. Yet, in these situations, the user will be able to take practice questions using the mobile device 12. Also, such a feature obviates the need for the user to carry a computer or exam practice book(s) for the purpose of taking practice questions.

Returning to FIG. 3, as discussed, the page 60 also includes the “Take timed exam” button 102. When the user of the mobile device 12 selects the “Take timed exam” button 102, the database 14 provides a series of simulated exam questions in a simulated exam session for display on the screen 20 of the mobile device 12. Each simulated exam question may have the format like that shown in the example of FIG. 6A. The user may answer each simulated exam question by selecting one of the multiple choices 306a-306d, as similarly discussed with reference to FIG. 6B. However, unlike the practice question mode described with reference to FIG. 6C in which the database 14 provides feedback to the user after the user answers each practice question, when the user is in the practice exam mode, the database 14 does not provide any immediate feedback. Instead, as the user goes through the practice exam using the mobile device 12, the database 14 keeps track of the information regarding the performance of the practice exam, and builds a statistic profile for the practice exam session using such information. By means of non-limiting examples, the information regarding the performance of the practice exam may include one or more of a total number of questions answered correctly, total number of questions answered incorrectly, number of questions answered correctly in each subject category, number of questions answered incorrectly in each subject category, and time the user spent in completing the practice exam. In the illustrated embodiments, the statistics regarding the performance of the practice exam is stored in a non-transitory medium associated with the database 14, so that the user of the mobile device 12 may be retrieved at a later time.

In the illustrated embodiments, the format of the practice exam provided by the database 14 is predetermined (e.g., by an administrator of the database 12). In other embodiments, the format of the practice exam may be configured by the user of the mobile device 12. For example, in some embodiments, when the “Take timed exam” button 102 is selected, the database 14 may provide a menu for display on the screen 20 of the mobile device 12, wherein the menu is configured to allow the user to configure the format (e.g., duration of the practice exam, number of questions in the practice exam, etc.) of the practice exam. In one implementation, the user is allowed to customize either the duration of a practice exam session, or the number of practice questions in the practice exam session. In another implementation, the user is allowed to customize one or both of the duration of a practice exam session and the number of practice questions in the practice exam session.

Based on the format configured by the user of the mobile device 12, the database 14 then provides the practice exam in accordance with the configured format. In other embodiments, the database 14 may provide a list of different veterinary exams for display on the screen 20 of the mobile device 12, wherein each of the veterinary exams has a format associated therewith. By means of non-limiting examples, the list of veterinary exams may include NAVLE, BCSE, PAVE, VLE, CPE, State Board examination, veterinary school class examination, specialty board exam, continuing education exam, a board examination that is mandatory for veterinary students (e.g., after completing the second year of veterinary school). When the user of the mobile device 12 selects one of the veterinary exams, the database 14 then provides a practice exam for the user of the mobile device 12 in accordance with the format that is associated with the selected one of the veterinary exams. In some embodiments, the database 14 also provides a “Pause” button for allowing the user of the mobile device 12 to pause a practice exam session, and a “Resume” button for allowing the user to resume the practice exam session. When the practice exam session is paused, the timing of the practice exam will also be paused. When the practice exam session is resumed, the timing of the practice exam will be resumed.

The feature of allowing the user to take practice exam(s) using the mobile device 12 is advantageous. Such a feature allows the user to take practice exam(s) anywhere. For example, the user may be commuting in a bus or train, may be waiting in line, or may be at a location where there is no power and/or wi-fi for a computer. Yet, in these situations, the user will be able to take practice exam(s) using the mobile device 12. Also, such a feature obviates the need for the user to carry a computer or exam practice book(s) for the purpose of taking practice exam(s).

Returning to FIG. 3, the page 60 also includes a progress section that includes a progress chart 110, a link/button 120 for accessing the statistics of the user's practice questions, and a link/button 122 for accessing exam results and statistics. The progress chart 110 allows a user to see how much of the exam preparation course the user has completed. The progress chart 110 also allows a user to compare his/her progress to other users, and inform the user of his/her total subscription time to help the user budget study time. The information from the progress chart 110 may be obtained by the database 14 or the mobile device 12 by accessing the attribute values for the attributes that are associated with the practice questions, and processing (e.g., filtering) those attribute values.

In the illustrated embodiments, the progress chart 110 includes a “You” bar that shows the percentage of veterinary exam practice questions the user has completed. In one implementation, the percentage of practice questions completed (percentage of completion) may be determined (using the database 14 and/or the mobile device 12) by determining the total number of questions that have been answered by the user, and divide such number by the total number of available questions. In some cases, the total number of questions answered correctly may be determined by counting all questions with status attribute's value equal to “1” (with “1” representing a correctly answered question, and “0” representing a question that has been answered incorrectly).

The progress chart 110 also includes an “Others” bar that shows the average (mean) percentage of the course that all other users have completed over the same time period (e.g., users who have completed the practice questions during the last month, the last three months, or other prescribed period). In some embodiments, the information in the “Others” bar may be obtained by accessing the attribute values of the practice questions for other users, and processing (e.g., filtering) those attribute values. For example, the percentage shown in the “Others” bar may be determined (using the database 14 and/or the mobile device 12) by determining the percentages of completion for all respective users, and calculating an average of the percentages of completion.

The progress chart 110 further includes a “Time” bar that shows the percentage of the length of the user's subscription that has expired. In the illustrated embodiments, each subscription to the database 14 by the user has a prescribed duration (e.g., 3 months). The database 14 and/or the mobile device 12 keeps track of the date on which the user signed up for the subscription, and determines the duration of the subscription that has expired (e.g., by determining a difference between the current date and the sign-up date). In the illustrated embodiments, the percentage shown in the “Time” bar may be determined by dividing the duration of the subscription that has expired by the total prescribed duration (e.g., 3 months).

As shown in the figure, the page 60 further includes a link/button 112, which may be selected by the user to allow the user to learn about the progress chart 110.

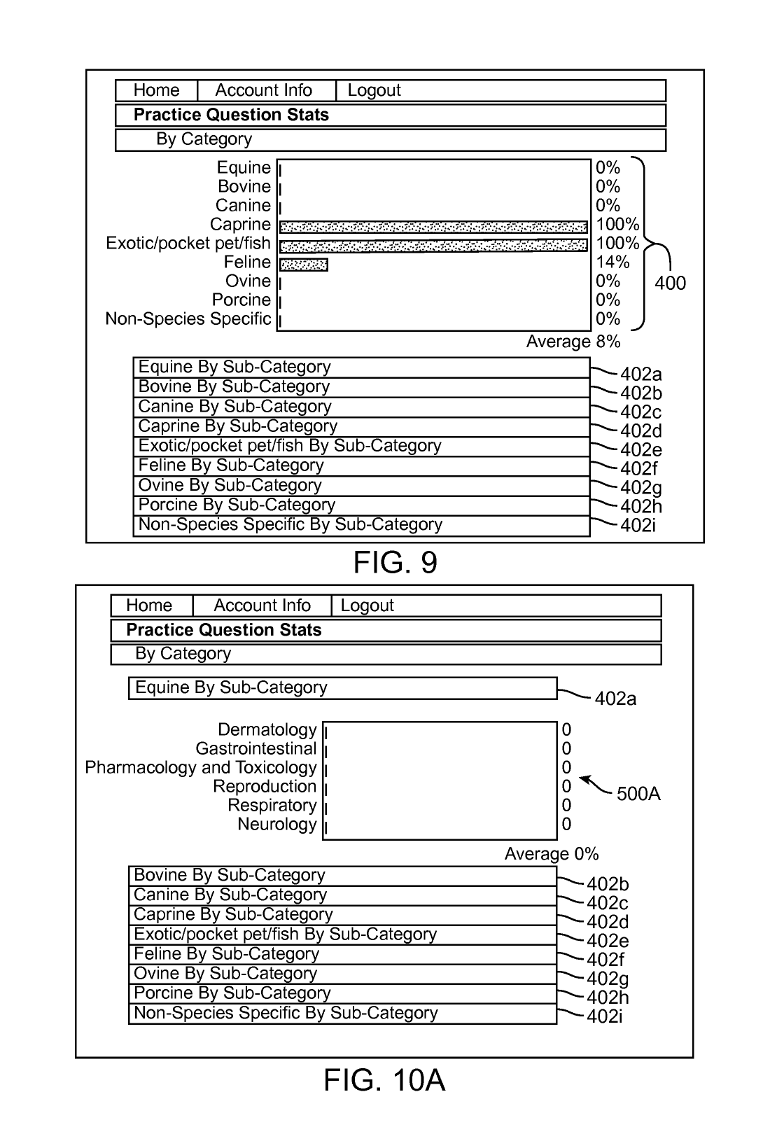

As discussed, when the user is in the practice question mode, the database 14 keeps track of the statistics of the user's performance. From the page 60, the user has the option of accessing such statistics by selecting the link/button 120. In some embodiments, when the link/button 120 is selected by the user (e.g., by touching the screen 20 of the mobile device 12 where the link/button 120 is located), the database 14 provides a summary of the number of questions answered correctly for each subject category for display on the screen 20 of the mobile device 12. For example, as shown in FIG. 9, the database 14 may provide a chart 400 for display on the screen 20 of the mobile device 12 that lists the subject categories (Equine, Bovine, Canine, Caprine, Exotic/pocket pet/fish, Feline, Ovine, Porcine, and Non-species specific), and the percentage of questions answered correctly for each subject category. The percentage of questions answered correctly may be determined by dividing the number of questions answered correctly for each subject category, by the total number of questions in the corresponding subject category. In one implementation, the total number of practice questions in each subject category (e.g., for subject category of “Equine”) may be determined (using the database 14, the mobile device 12, or combination of both) by counting all of the questions with a certain subject category attribute's value (e.g., subject category attribute's value equal to “Equine”). Also, the number of questions answered correctly for each subject category (e.g., for subject category of “Equine”) may be determined (using the database 14, the mobile device 12, or combination of both) by counting all of the questions with a certain subject category attribute's value (e.g., subject category attribute's value equal to “Equine”), and with status attribute's value equal to “1” (or other prescribed value for representing a correctly answered question). The same technique may be used to determine the percentage of questions answered correctly for other subject categories. In the illustrated embodiments, the order of the subject categories is fixed and is predetermined. In other embodiments, the order of the subject categories in the chart 400 may be automatically sorted by the database 14 or the mobile device 12 based on number of most missed questions (in which the subject categories with more missed questions are arranged first), or number of least missed questions (in which the subject categories with fewer missed questions are arranged first).

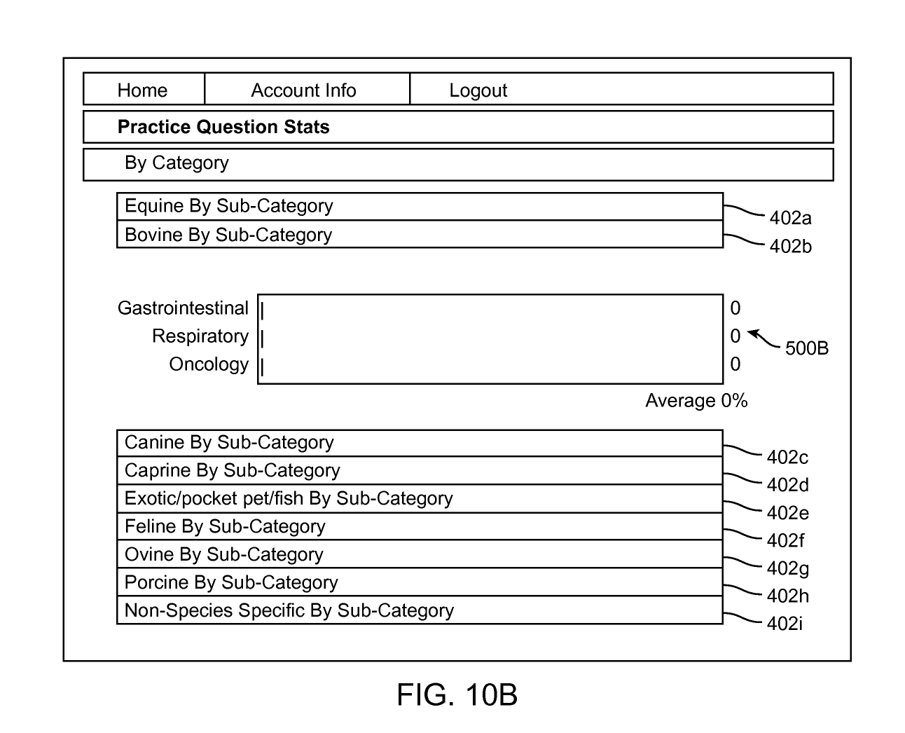

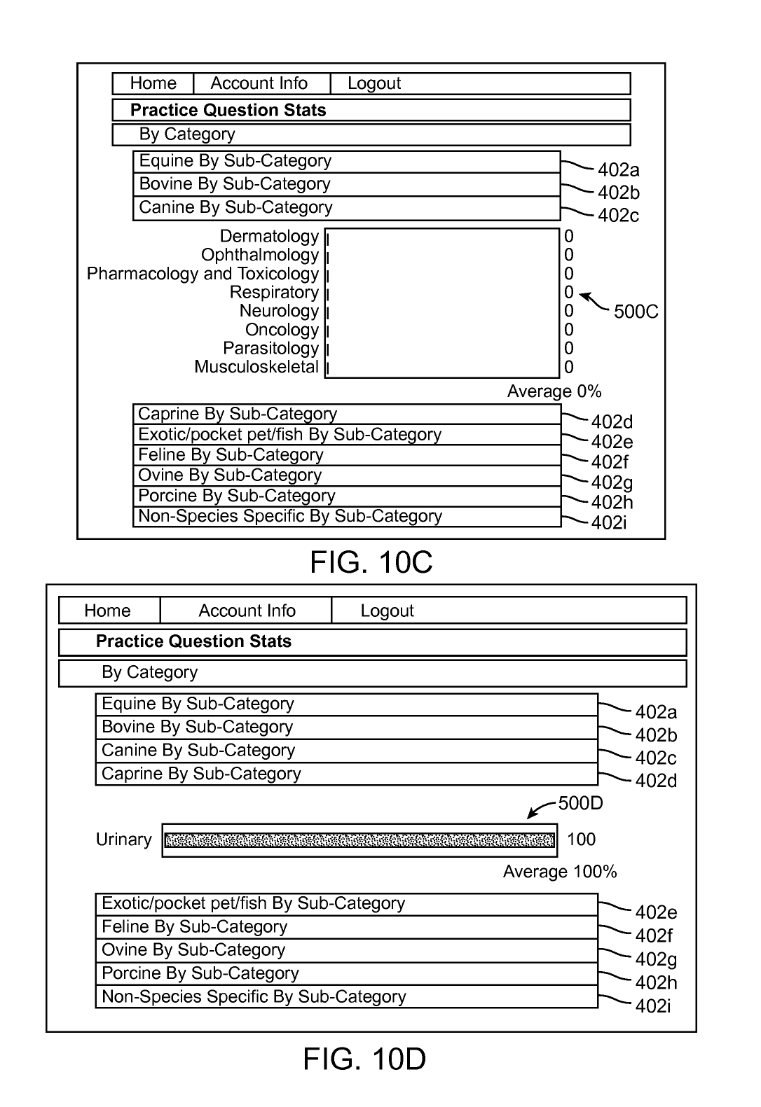

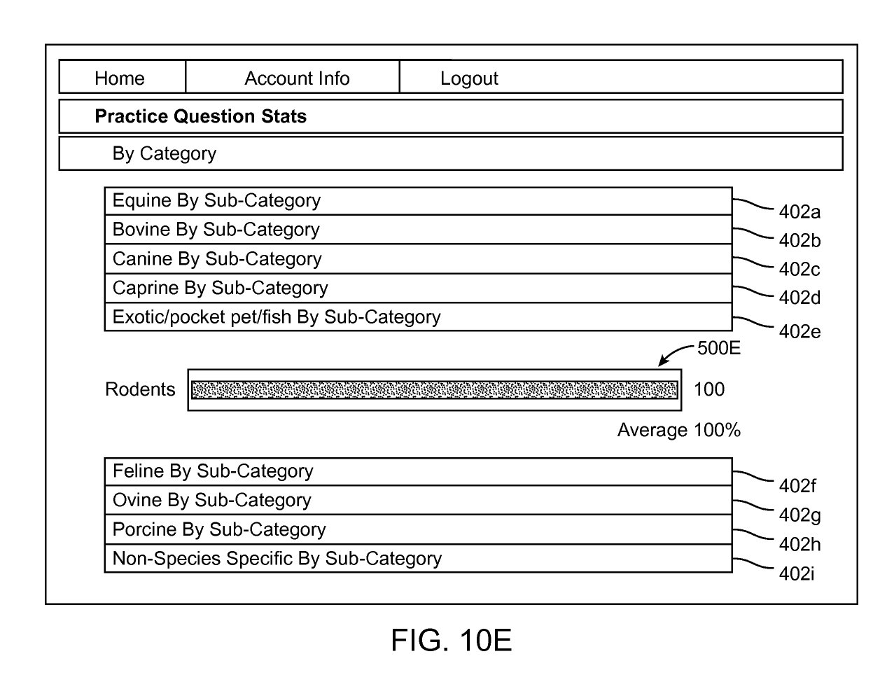

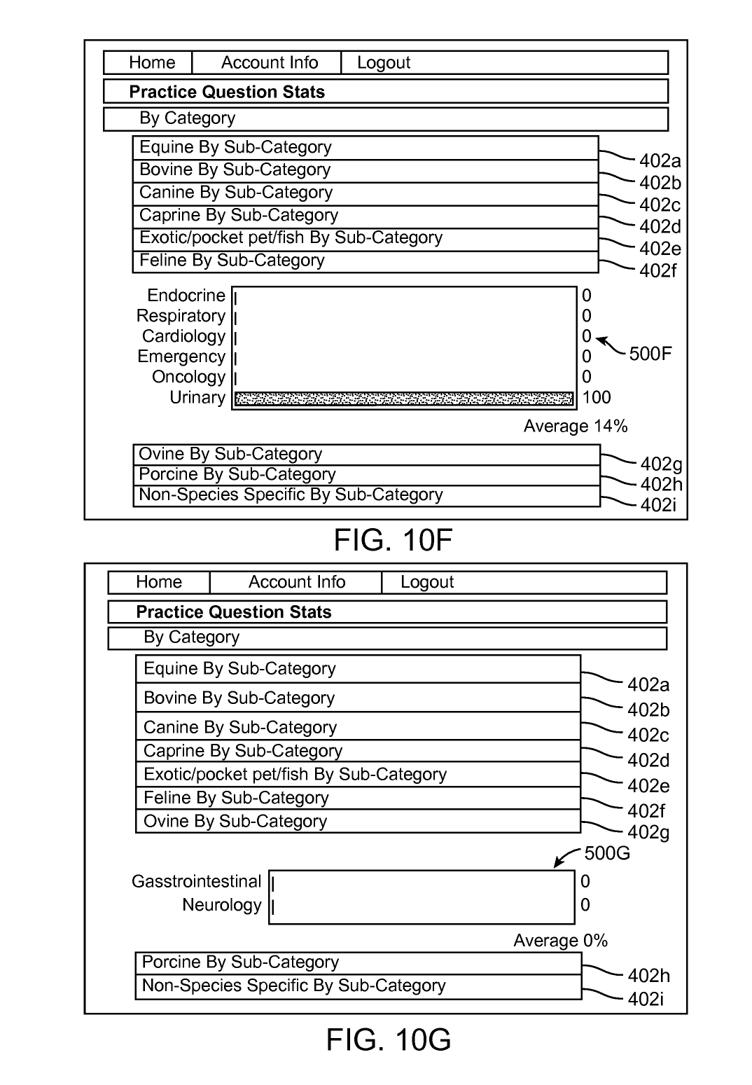

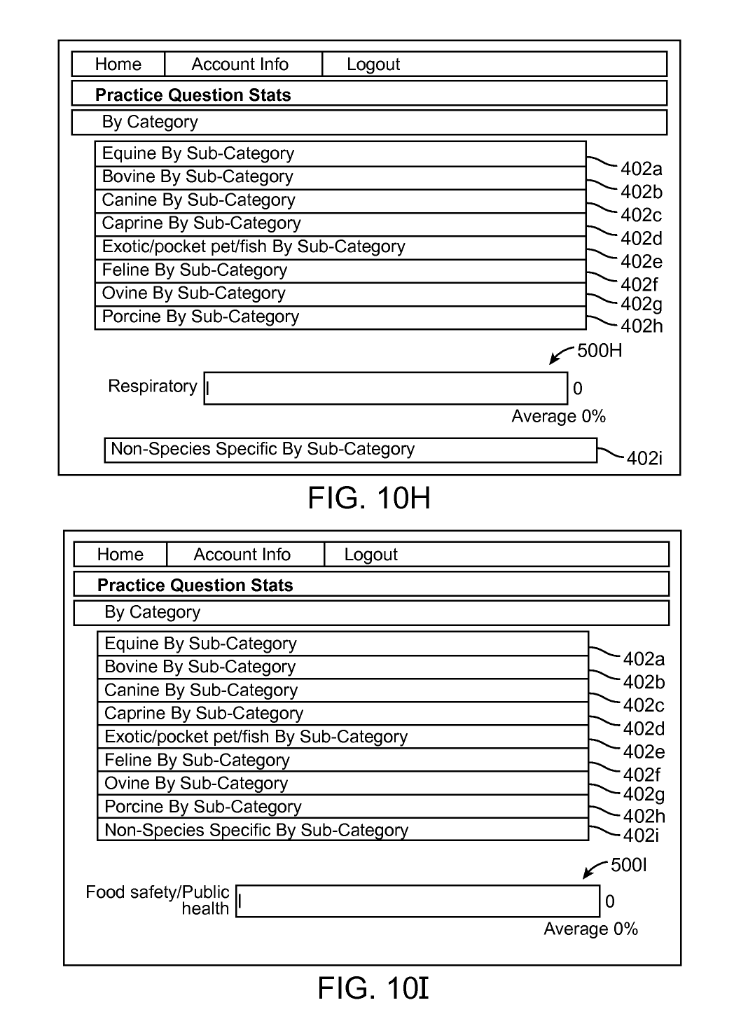

The database 14 may also provide a plurality of links/buttons 402a-402i for display on the screen 20 of the mobile device 12, wherein each of the links/buttons 402a-402i may be selected by the user to provide statistics of sub-categories for the respective subject categories. In particular, as shown in FIG. 10A, when the link/button 402a for the “Equine” subject category is selected, the database 14 then provides a chart 500a for display on the screen 20 of the mobile device 12 that lists the sub-categories (Dermatology, Gastrointestinal, Pharmacology and Toxicology, Reproduction, Respiratory, and Neurology) of “Equine,” and the percentage of questions answered correctly for each sub-category under the “Equine” category. In the illustrated example, the “Equine” category has six sub-categories. In other examples, the “Equine” category may have more or less than six sub-categories.

As shown in FIG. 10B, when the link/button 402b for the “Bovine” subject category is selected, the database 14 then provides a chart 500b for display on the screen 20 of the mobile device 12 that lists the sub-categories (Gastrointestinal, Respiratory, and Oncology) of “Bovine,” and the percentage of questions answered correctly for each sub-category under the “Bovine” category. In the illustrated example, the “Bovine” category has three sub-categories. In other examples, the “Bovine” category may have more or less than three sub-categories.

As shown in FIG. 10C, when the link/button 402c for the “Canine” subject category is selected, the database 14 then provides a chart 500c for display on the screen 20 of the mobile device 12 that lists the sub-categories (Dermatology, Ophthalmology, Pharmacology and Toxicology, Respiratory, Neurology, Oncology, Parasitology, and Musculoskeletal) of “Canine,” and the percentage of questions answered correctly for each sub-category under the “Canine” category. In the illustrated example, the “Canine” category has eight sub-categories. In other examples, the “Canine” category may have more or less than eight sub-categories.

As shown in FIG. 10D, when the link/button 402d for the “Caprine” subject category is selected, the database 14 then provides a chart 500d for display on the screen 20 of the mobile device 12 that lists the sub-category (Urinary) of “Caprine,” and the percentage of questions answered correctly for each sub-category under the “Caprine” category. In the illustrated example, the “Caprine” subject has only one sub-category. However, in other examples, the “Caprine” subject may have a plurality of sub-categories.

As shown in FIG. 10E, when the link/button 402e for the “Exotic/pocket pet/fish” subject category is selected, the database 14 then provides a chart 500e for display on the screen 20 of the mobile device 12 that lists the sub-category (Rodents) of “Exotic/pocket pet/fish,” and the percentage of questions answered correctly for each sub-category under such category. In the illustrated example, the “Exotic/pocket pet/fish” subject has only one sub-category. However, in other examples, the “Exotic/pocket pet/fish” subject may have a plurality of sub-categories.

As shown in FIG. 10F, when the link/button 402f for the “Feline” subject category is selected, the database 14 then provides a chart 500f for display on the screen 20 of the mobile device 12 that lists the sub-categories (Endocrine, Respiratory, Cardiology, Emergency, Oncology, and Urinary) of “Feline,” and the percentage of questions answered correctly for each sub-category under the “Feline” category. In the illustrated example, the “Feline” subject has six sub-categories. However, in other examples, the “Feline” subject may have more or less than six sub-categories.

As shown in FIG. 10G, when the link/button 402g for the “Ovine” subject category is selected, the database 14 then provides a chart 500g for display on the screen 20 of the mobile device 12 that lists the sub-categories (Gastrointestinal and Neurology) of “Ovine,” and the percentage of questions answered correctly for each sub-category under the “Ovine” category. In the illustrated example, the “Ovine” subject has two sub-categories. However, in other examples, the “Ovine” subject may have more or less than two sub-categories.

As shown in FIG. 10H, when the link/button 402h for the “Porcine” subject category is selected, the database 14 then provides a chart 500h for display on the screen 20 of the mobile device 12 that lists the sub-category (Respiratory) of “Porcine,” and the percentage of questions answered correctly for each sub-category under the “Porcine” category. In the illustrated example, the “Porcine” subject has one sub-category. However, in other examples, the “Porcine” subject may have a plurality of sub-categories.

As shown in FIG. 10I, when the link/button 402i for the “Non-species specific” subject category is selected, the database 14 then provides a chart 500i for display on the screen 20 of the mobile device 12 that lists the sub-category (Food safety/Public health) of “Non-species specific,” and the percentage of questions answered correctly for each sub-category under the “Non-species specific” category. In the illustrated example, the “Non-species specific” subject has one sub-category. However, in other examples, the “Non-species specific” subject may have a plurality of sub-categories.

The percentage of questions answered correctly for a subject sub-category may be determined by dividing the number of questions answered correctly for the subject sub-category, by the total number of questions in the corresponding subject sub-category. In one implementation, the total number of practice questions in each subject sub-category (e.g., for subject sub-category of “Dermatology” under the subject category “Equine”) may be determined (using the database 14, the mobile device 12, or combination of both) by counting all of the questions with a certain subject category attribute's value (e.g., subject category attribute's value equal to “Equine”), and with a certain subject sub-category attribute's value (e.g., subject sub-category attribute's value equal to “Dermatology”). Also, the number of questions answered correctly for each subject sub-category (e.g., for subject sub-category of “Dermatology” under the subject category “Equine”) may be determined (using the database 14, the mobile device 12, or combination of both) by counting all of the questions with a certain subject category attribute's value (e.g., subject category attribute's value equal to “Equine”), with a certain subject sub-category attribute's value (e.g., subject sub-category attribute's value equal to “Dermatology”), and with status attribute's value equal to “1” (or other prescribed value for representing a correctly answered question). The same technique may be used to determine the percentage of questions answered correctly for other subject sub-categories.

Returning to FIG. 3, as discussed, the page 60 includes the link/button 122 for accessing exam results and statistics. In the illustrated embodiments, when the link/button 122 is selected by the user (e.g., by touching the screen 20 of the mobile device 12 where the link/button 120 is located), the database 14 provides a summary of the number of questions answered correctly in a practice exam session for each subject category for display on the screen 20 of the mobile device 12. For example, the database 14 may provide a chart (e.g., like that shown in FIG. 9) for display on the screen 20 of the mobile device 12 that lists the subject categories (Equine, Bovine, Canine, Caprine, Exotic/pocket pet/fish, Feline, Ovine, Porcine, and Non-species specific), and the percentage of questions answered correctly for each subject category. The database 14 may also provide a plurality of links/buttons (like elements 402a-402i described previously with reference to FIGS. 10A-10I) for display on the screen 20 of the mobile device 12, wherein each of the links/buttons may be selected by the user to provide statistics of sub-categories for the respective subject categories.

Returning to FIG. 3, the page 60 also includes a link/button 130. In the illustrated embodiments, the database 14 is configured to remember which questions a user missed and provide them again for display on the screen 20 of the mobile device 12 at a later time. For example, the database 14 may be configured to flag one or more questions that have been missed by the user. For the flagged questions that have been missed, the database 14 can provide them again when the user is using the practice question function (which is discussed with reference to element 100 and FIGS. 6A-6C. This helps to ensure that the user learns the material he/she needs to know before putting it behind. Some users may prefer to have an opportunity to specifically revisit questions that he/she has previously missed to focus on the areas where improvement is needed. In such cases, the database 14 may be configured to provide information for allowing a user to review the questions that have been previously missed. For example, the user can view a list of the questions that he/she has previously missed and see how many times each question was missed. If the user has not answered the question correctly, the user can also re-take the missed practice questions. For example, the database 14 may provide a link/button for taking missed practice questions, which when selected by the user, will provide only those practice questions that have been missed previously.

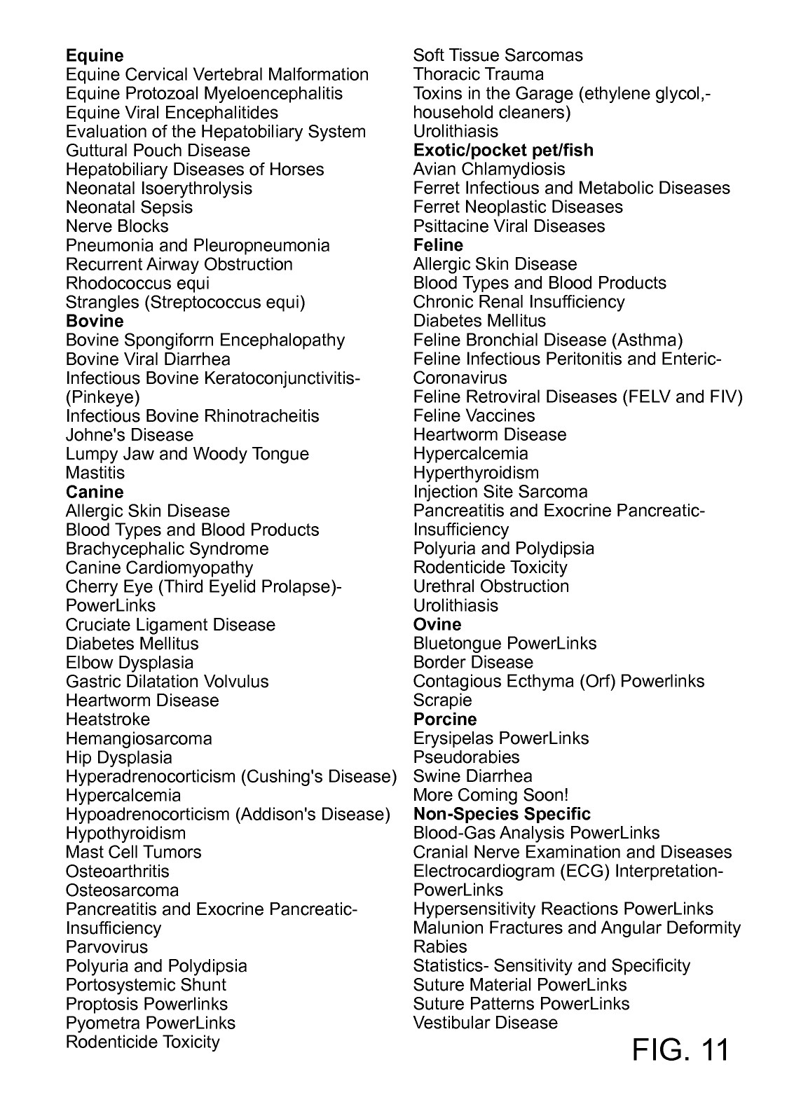

As shown in FIG. 3, the database 14 also provides a link/button 132 for display on the screen 20 of the mobile device 12. When the user of the mobile device 12 selects the link/button 132, the database 14 provides study materials for the user. In the illustrated embodiments, the database 14 is configured to provide a list of subject categories, and their respective sub-categories, for display on the screen 20 of the mobile device 12, so that the user can select any one of them (FIG. 11). When the user selects one of the sub-categories, the database 14 then provides further information regarding the selected sub-category, such as lecture notes, outline, etc., that pertains to the selected sub-category within the veterinary field. Also, in some embodiments, when the user selects one of the main categories (e.g., Equine, Bovine, Canine, Exotic/pocket pet/fish, Feline, Ovine, Porcine, and Non-species specific), the database 14 then provides information (e.g., lecture notes, outline, etc.) regarding the selected category that includes all of the sub-categories.

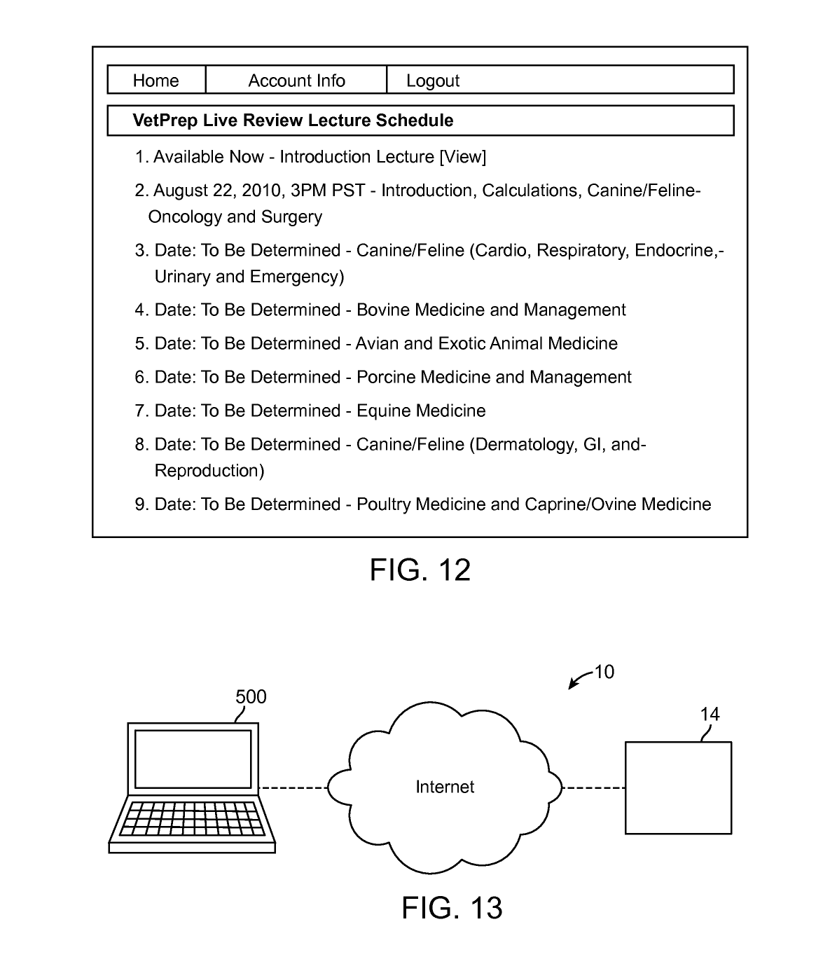

As shown in FIG. 3, the database 14 also provides a link/button 134 for display on the screen 20 of the mobile device 12. When the user of the mobile device 12 selects the link/button 134, the database 14 provides one or more videos for assisting the user in studying certain subject areas. For example, the database 14 may provide a schedule of live lectures organized by subject matter for display on the screen 20 of the mobile device 12 (FIG. 12). When the user selects one of the lectures (e.g., by touching a portion of the screen 20) for a certain subject area, the database 14 then provides a video for that subject area for presentation on the screen 20 of the mobile device 12. In the illustrated example, the video is a live lecture. In other embodiments, the video may be a pre-recorded lecture. Also, the video may be a live stream, or alternatively, be downloaded to the mobile device 12 for storage as a file in the mobile device 12. The video feature is advantageous because it allows the user to have access of the lecture(s) anywhere, e.g., even when the user is commuting. For example, the user may be sitting in a bus, and the user will be able to view the study video for preparing the veterinary exam using the mobile device 12. It should be noted that the database 14 is not limited to providing video lectures, and may be configured to provide other forms of lectures in other embodiments, such as, audio lectures, text lectures. Also, in other embodiments, the lectures may be online lectures. In such cases, the database 14 may provide link(s) for allowing the user to access any of the available online lectures.

It should be noted that any of the functions described herein may be implemented by configuring (e.g., designing, constructing, programming, or any combination of the foregoing) the database 14, the mobile device 12, or both the database 14 and the mobile device 12. For example, in some embodiments, the database 14 may include a processor that is programmed to provide any of the functions described herein. Also, any of the functions described herein may be implemented as a function of a web page (e.g., using HTML). In further embodiments, the mobile device 12 may be programmed (e.g., by downloading a software, receiving instructions, and/or receiving a web page includes one or more functions, either from the database 14 or from another source that is associated (e.g., another content provider) with the database 14) to provide any of the functions described herein. In still further embodiments, all of the functions described herein may be implemented as a software that is downloaded from the database 14 and is stored in the mobile device 12.

In the above embodiments, the various features provided by the database 14 were described as being presented for the mobile device 12. In other embodiments, instead of the mobile device 12, any of the features described herein may be provided by the database 14 for a user who is using a computer 500 (FIG. 13). In further embodiments, any of the features described herein may be provided by the database 14 for a user who is using a TV. Thus, any of the features (e.g., functions, capabilities, configuring of the device, etc.) described with reference to the mobile device 12 may be applicable for a computer or a TV.

Computer System Architecture

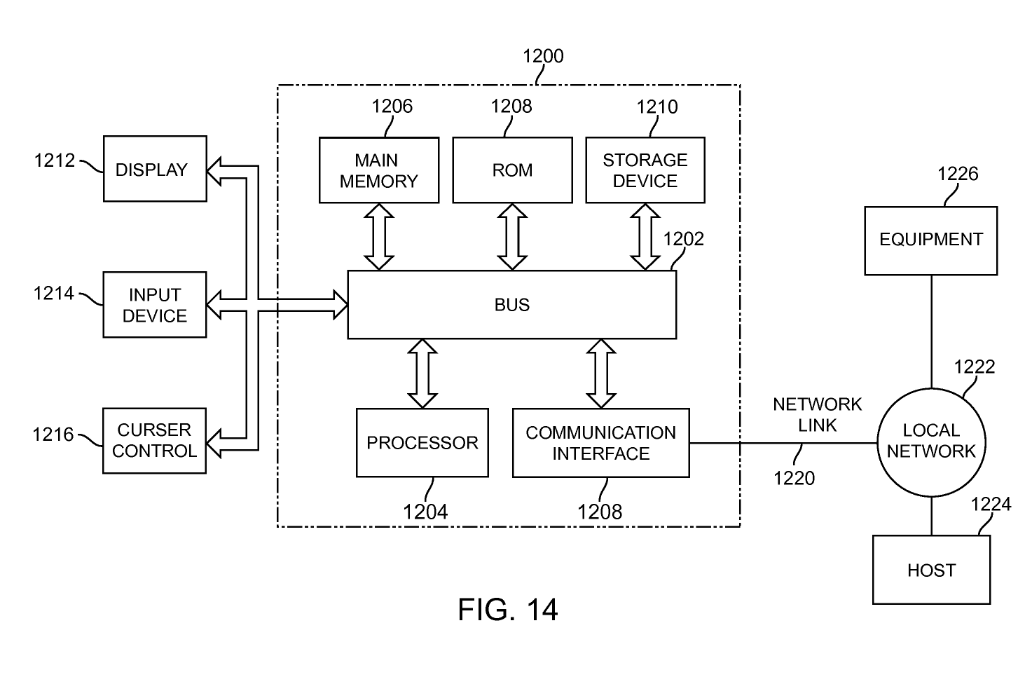

FIG. 14 is a block diagram that illustrates an embodiment of a computer system 1200 upon which an embodiment of the invention may be implemented. Computer system 1200 includes a bus 1202 or other communication mechanism for communicating information, and a processor 1204 coupled with the bus 1202 for processing information. The processor 1204 may be a part of the database 14 of FIG. 1, or another processor (such as the processor in the computer 500 of FIG. 13) that is used to perform various functions described herein. The computer system 1200 also includes a main memory 1206, such as a random access memory (RAM) or other dynamic storage device, coupled to the bus 1202 for storing information and instructions to be executed by the processor 1204. The main memory 1206 also may be used for storing temporary variables or other intermediate information during execution of instructions to be executed by the processor 1204. The computer system 1200 further includes a read only memory (ROM) 1208 or other static storage device coupled to the bus 1202 for storing static information and instructions for the processor 1204. A data storage device 1210, such as a magnetic disk or optical disk, is provided and coupled to the bus 1202 for storing information and instructions.

The computer system 1200 may be coupled via the bus 1202 to a display 1212, such as a cathode ray tube (CRT) or a flat panel, for displaying information to a user. An input device 1214, including alphanumeric and other keys, is coupled to the bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

The computer system 1200 may be used for performing various functions (e.g., calculation) in accordance with the embodiments described herein. According to one embodiment, such use is provided by computer system 1200 in response to processor 1204 executing one or more sequences of one or more instructions contained in the main memory 1206. Such instructions may be read into the main memory 1206 from another computer-readable medium, such as storage device 1210. Execution of the sequences of instructions contained in the main memory 1206 causes the processor 1204 to perform the one or more of the functions described herein. One or more processors in a multi-processing arrangement may also be employed to execute the sequences of instructions contained in the main memory 1206. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor 1204 for execution. Such a medium may take many forms, including but not limited to, non-volatile media, volatile media, and transmission media. Non-volatile media includes, for example, optical or magnetic disks, such as the storage device 1210. A non-volatile medium may be considered to be an example of a non-transitory medium. Volatile media includes dynamic memory, such as the main memory 1206. A volatile medium may be considered to be another example of a non-transitory medium. Transmission media includes coaxial cables, copper wire and fiber optics, including the wires that comprise the bus 1202. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to the processor 1204 for execution. For example, the instructions may initially be carried on a magnetic disk of a remote computer. The remote computer can load the instructions into its dynamic memory and send the instructions over a telephone line using a modem. A modem local to the computer system 1200 can receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1206, from which the processor 1204 retrieves and executes the instructions. The instructions received by the main memory 1206 may optionally be stored on the storage device 1210 either before or after execution by the processor 1204.

The computer system 1200 also includes a communication interface 1218 coupled to the bus 1202. The communication interface 1218 provides a two-way data communication coupling to a network link 1220 that is connected to a local network 1222. For example, the communication interface 1218 may be an integrated services digital network (ISDN) card or a modem to provide a data communication connection to a corresponding type of telephone line. As another example, the communication interface 1218 may be a local area network (LAN) card to provide a data communication connection to a compatible LAN. Wireless links may also be implemented. In any such implementation, the communication interface 1218 sends and receives electrical, electromagnetic or optical signals that carry data streams representing various types of information.

The network link 1220 typically provides data communication through one or more networks to other devices. For example, the network link 1220 may provide a connection through local network 1222 to a host computer 1224 or to equipment 1226. The data streams transported over the network link 1220 can comprise electrical, electromagnetic or optical signals. The signals through the various networks and the signals on the network link 1220 and through the communication interface 1218, which carry data to and from the computer system 1200, are exemplary forms of carrier waves transporting the information. The computer system 1200 can send messages and receive data, including program code, through the network(s), the network link 1220, and the communication interface 1218.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. For example, the term “page” needs not be limited to a web page, and may refer to any presentation of information that is displayed on a screen. In addition, any information described herein as being presented in a page may alternatively be presented in a plurality of pages. Furthermore, any information described herein as being presented in different pages may alternatively be presented in a single page. Also, the term “processor” may include one or more processing units, and may refer to any device that is capable of performing mathematical computation implemented using hardware and/or software. For example, in some embodiments, any processor described herein (such as the processor associated with database 14) may be implemented using one or more computers. The specification and drawings are, accordingly, to be regarded in an illustrative rather than restrictive sense. The present inventions are intended to cover alternatives, modifications, and equivalents, which may be included within the spirit and scope of the present inventions as defined by the claims.

What is claimed:

1. An apparatus for use in a process to assist a user to prepare for a veterinary examination, comprising:
a computer-readable non-transitory medium storing a veterinary exam practice question, and a plurality of answers that correspond to the veterinary exam practice question; and
a processor configured to:
receive a request from a mobile device,
access the medium to retrieve the veterinary exam practice question and the plurality of answers in response to the received request, and
provide the retrieved veterinary exam practice question and the plurality of answers for display on the mobile device.

2. The apparatus of claim 1, wherein the processor is further configured to receive an input from the mobile device, wherein the input represents a selection of one of the plurality of answers.

3. The apparatus of claim 2, wherein the processor is further configured to highlight the selected one of the plurality of answers based on the input.

4. The apparatus of claim 2, wherein the processor is further configured to determine whether the selected one of the plurality of answers is a correct answer or not.

5. The apparatus of claim 4, wherein the processor is further configured to provide an indication for display on the mobile device for indicating to a user of the mobile device whether the selected one of the plurality of answers is the correct answer or not.

6. The apparatus of claim 1, wherein the veterinary exam practice question includes a picture associated therewith, and wherein the processor is further configured to provide the picture for display on the mobile device.

7. The apparatus of claim 1, wherein the processor is further configured to provide an explanation of a correct answer for display on the mobile device.

8. The apparatus of claim 1, wherein the processor is further configured to provide information regarding reading material that is associated with a correct answer.

9. The apparatus of claim 8, wherein the information is provided in a form of a web page, a text, a pdf, a video, an audio file, or a link.

10. The apparatus of claim 1, wherein the veterinary exam practice question is retrieved from a pool of available questions.

11. The apparatus of claim 10, wherein the pool of available questions is variable to exclude one or more questions for which one or more respective correct answers have been obtained.

12. The apparatus of claim 10, wherein the veterinary exam practice question is selected from the pool of the available questions based on user performance.

13. The apparatus of claim 1, wherein the processor is further configured to:
receive an input from the mobile communication device that represents a user preference of receiving questions with images, questions without images, or questions with and without images;
wherein the processor is configured to provide the veterinary exam practice question based on the received input.

14. The apparatus of claim 1, wherein the processor is further configured to:
receive an input from the mobile communication device that represents a user-defined duration for a practice exam, and
provide one or more additional veterinary exam practice questions for display on the mobile device until the user-defined duration has lapsed.

15. The apparatus of claim 1, wherein the processor is further configured to:
receive an input from the mobile communication device that represents a user-prescribed number of veterinary exam practice questions, and
provide one or more additional veterinary exam practice questions for display on the mobile device until a number of the provided questions has reached the user-prescribed number.

16. The apparatus of claim 1, wherein the processor is further configured to:
receive a command from the mobile device for marking the question to be reviewed later, and
set a flag associated with the question in response to the received command.

17. The apparatus of claim 1, wherein the processor is further configured to provide information regarding a performance of a practice exam session for display on the mobile communication device, wherein the practice exam session includes the veterinary exam practice question.

18. The apparatus of claim 17, wherein the information comprises numbers of missed questions or correctly answered questions that are organized by subject categories.

19. The apparatus of claim 17, wherein the information comprises a result of a comparison between the performance of the practice exam session and a performance of another practice exam session.

20. A method for use in a process to assist a user to prepare for a veterinary examination, comprising:
receiving a request from a mobile device;
accessing a computer-readable non-transitory medium to retrieve a veterinary exam practice question and a plurality of answers in response to the received request; and
providing the retrieved veterinary exam practice question and the plurality of answers for display on the mobile device.

21. The method of claim 20, further comprising receiving an input from the mobile device, wherein the input represents a selection of one of the plurality of answers.

22. The method of claim 21, further comprising highlighting the selected one of the plurality of answers based on the input.

23. The method of claim 21, wherein the processor is further configured to determine whether the selected one of the plurality of answers is a correct answer or not.

24. The method of claim 23, further comprising providing an indication for display on the mobile device for indicating to a user of the mobile device whether the selected one of the plurality of answers is the correct answer or not.

25. The method of claim 20, further comprising providing an explanation of a correct answer for display on the mobile device.

26. The method of claim 20, further comprising providing information regarding reading material that is associated with a correct answer.

27. The method of claim 26, wherein the information is provided in a form of a web page, a text, a pdf, a video, an audio file, or a link.

28. The method of claim 20, wherein the veterinary exam practice question is retrieved from a pool of available questions.

29. The method of claim 28, wherein the pool of available questions is variable to exclude one or more questions for which one or more respective correct answers have been obtained.

30. The method of claim 28, wherein the veterinary exam practice question is selected from the pool of the available questions based on user performance.

31. The method of claim 20, further comprising:
receiving an input from the mobile communication device that represents a user preference of receiving questions with images, questions without images, or questions with and without images;
wherein the veterinary exam practice question is provided based on the received input.

32. The method of claim 20, further comprising:
receiving an input from the mobile communication device that represents a user-defined duration for a practice exam, and
providing one or more additional veterinary exam practice questions for display on the mobile device until the user-defined duration has lapsed.

33. The method of claim 20, further comprising:
receiving an input from the mobile communication device that represents a user-prescribed number of veterinary exam practice questions, and
providing one or more additional veterinary exam practice questions for display on the mobile device until a number of the provided questions has reached the user-prescribed number.

34. The method of claim 20, further comprising:
receiving a command from the mobile device for marking the question to be reviewed later, and
setting a flag associated with the question in response to the received command.

35. The method of claim 20, further comprising providing information regarding a performance of a practice exam session for display on the mobile communication device, wherein the practice exam session includes the veterinary exam practice question.

36. The method of claim 35, wherein the information comprises numbers of missed questions or correctly answered questions that are organized by subject categories.

37. The method of claim 35, wherein the information comprises a result of a comparison between the performance of the practice exam session and a performance of another practice exam session.

38. A computer-readable non-transitory medium having a set of stored instructions, an execution of which causes a method to be performed, the method comprising:
receiving a request from a mobile device;
accessing a computer-readable non-transitory medium to retrieve a veterinary exam practice question and a plurality of answers in response to the received request; and
providing the retrieved veterinary exam practice question and the plurality of answers for display on the mobile device.

39. The computer-readable non-transitory medium of claim 38, wherein the method further comprises receiving an input from the mobile device, wherein the input represents a selection of one of the plurality of answers.

40. The computer-readable non-transitory medium of claim 39, wherein the method further comprises determining whether the selected one of the plurality of answers is a correct answer or not.

41. The computer-readable non-transitory medium of claim 38, wherein the method further comprises providing an explanation of a correct answer for display on the mobile device.

42. The computer-readable non-transitory medium of claim 38, wherein the method further comprises providing information regarding reading material that is associated with a correct answer.

43. The computer-readable non-transitory medium of claim 38, wherein the method further comprises retrieving the veterinary exam practice question from a pool of available questions based on user performance.

44. The computer-readable non-transitory medium of claim 38, wherein the method further comprises:
receiving an input from the mobile communication device that represents a user-defined duration for a practice exam, and
providing one or more additional veterinary exam practice questions for display on the mobile device until the user-defined duration has lapsed.

45. The computer-readable non-transitory medium of claim 38, wherein the method further comprises:
receiving an input from the mobile communication device that represents a user-prescribed number of veterinary exam practice questions, and
providing one or more additional veterinary exam practice questions for display on the mobile device until a number of the provided questions has reached the user-prescribed number.

46. The computer-readable non-transitory medium of claim 38, wherein the method further comprises:
receiving a command from the mobile device for marking the question to be reviewed later, and
setting a flag associated with the question in response to the received command.

47. The computer-readable non-transitory medium of claim 38, wherein the method further comprises providing information regarding a performance of a practice exam session for display on the mobile communication device, wherein the practice exam session includes the veterinary exam practice question.

48. The computer-readable non-transitory medium of claim 47, wherein the information comprises numbers of missed questions or correctly answered questions that are organized by subject categories.

49. The computer-readable non-transitory medium of claim 47, wherein the information comprises a result of a comparison between the performance of the practice exam session and a performance of another practice exam session.

50. An apparatus for assisting a user to prepare for a veterinary examination, comprising:
a mobile device having a screen for displaying information, and a user interface for receiving an input from the user;
wherein the portable device is configured to display a veterinary exam practice question and a plurality of answers on the screen; and
wherein the mobile device is further configured to allow the user to enter the input in response to the displayed veterinary exam practice question using the user interface.

51. A method for assisting a user to prepare for a veterinary examination, comprising:
receiving a veterinary exam practice question from a database;
receiving a plurality of answers that correspond with the veterinary exam practice question from the database;
displaying the veterinary exam practice question and the plurality of answers on a screen of a mobile device; and
receiving an input from a user at the mobile device.

52. A computer-readable non-transitory medium having a set of stored instructions, an execution of which causes a method to be performed, the method comprising:
receiving a veterinary exam practice question from a database;
receiving a plurality of answers that correspond with the veterinary exam practice question from the database;
displaying the veterinary exam practice question and the plurality of answers on a screen of a mobile device; and
receiving an input from a user at the mobile device.
